(19) United States
(12) Patent Application Publication
(10) Pub. No.: US 2012/0173570 A1
(43) Pub. Date: Jul. 5, 2012

(54) SYSTEMS AND METHODS FOR MANAGING FRAUD RING INVESTIGATIONS

(75) Inventor: Brian J. Golden, Boonton, NJ (US)

(73) Assignee: BANK OF AMERICA CORPORATION, Charlotte, NC (US)

(21) Appl. No.: 12/984,925

(22) Filed: Jan. 5, 2011

(51) Int. Cl. G06F 17/30; G06F 17/00

(52) U.S. Cl. 707/769; 707/812; 715/224; 715/205; 707/E17.005; 707/E17.014

(57) ABSTRACT

Various embodiments provide a fraud ring investigation management system that allows for the documentation and sharing of information related to one or more fraud ring investigations. In particular, the system provides a centralized workspace for documenting and sharing organized fraud ring intelligence and accessing ring investigation tools and various security resources. In certain embodiments, the system provides a web-based application accessible by fraud ring investigators via networked computing devices. Investigators use the application to enter data and store documents related to fraud ring investigations, to search for data related to various fraud ring investigations, and to access various fraud ring investigation tools and security resources.

### BACKGROUND OF INVENTION

A fraud ring refers to a pattern of known or suspected fraudulent activity by an organized group. The pattern of activity is typically identified by fraud elements that are common among various cases suspected to be a part of the fraud ring. Common fraud elements may include, for example, geographical area, modus operandi, receiving account(s), email address(es), physical address(es), Internet protocol (IP) address(es), sentinel cookie(s), automatic number identification (ANI) incoming phone number(s), primary fraud channel (e.g., online banking, ATMs, checks), suspect name(s), and any combination thereof. Fraud rings can create a significant amount of loss or exposure (actual or attempted) to an organization (e.g., $50,000 or greater), and fraud rings may affect multiple customers of the organization (e.g., customers of a financial institution).

To identify activities by a fraud ring and prevent further escalation of the fraud ring activities, organizations (e.g., financial institutions) may utilize a group of investigators that are responsible for investigating suspected fraud ring activity. These investigators, along with business partners of the organization (e.g., investigators of other financial institutions), identify groups of individuals working together to negatively impact the organization and the organization's business partners and customers.

In particular, in certain financial institutions, fraud investigators receive information from customers of the financial institution reporting fraudulent activity related to their financial accounts, which is referred to as an individual fraud case. When common fraud elements are identified among various cases, fraud investigators may suspect that the cases are part of a fraud ring. A fraud ring investigation is then launched. However, the current processes for documenting fraud rings and sharing fraud ring intelligence among investigators are decentralized and inefficient, which delays and/or inhibits the identification of fraud rings and the financial institution's ability to stop fraud rings from affecting its customers and accounts. Accordingly, there is a need in the art for systems and methods that improve the processes of documenting fraud rings and sharing information related to identified fraud rings.

### BRIEF SUMMARY OF INVENTION

According to various embodiments of the invention, a fraud ring investigation management system includes a fraud ring database and a fraud ring investigation application. The fraud ring database is configured to store a set of electronic data associated with each of one or more fraud ring investigations, and each set of electronic data comprises one or more fraud elements and a fraud ring identifier unique to each of the one or more fraud ring investigations. The fraud ring investigation application is configured to manage a network collection of the set of electronic data associated with each of the one or more fraud ring investigations. In certain embodiments, the one or more fraud elements include one or more of the following: a geographic location, an electronic mail address, a physical address, an internet protocol address, a suspect name, primary fraud channel, or a financial product.

In addition, in certain embodiments, the set of electronic data associated with each of the one or more fraud ring investigations includes a first set of electronic data associated with a first fraud ring investigation and a second set of electronic data associated with a second fraud ring investigation. The fraud ring investigation application is further configured to receive electronically via a communications network the first set of electronic data from a first investigator computing device and the second set of electronic data from a second investigator computing device, wherein the first investigator computing device and the second investigator computing device are disposed remotely from each other.

Specifically, in a particular embodiment, the fraud ring investigation application is configured to: (1) generate, via a computer processor, a fillable form; (2) electronically communicate the fillable form via the communications network to the first investigator computing device and the second investigator computing device; (3) receive the first set of electronic data into the fillable form from the first investigator computing device; (4) receive the second set of electronic data into the fillable form from the second investigator computing device; and (5) communicate the first set of electronic data and the second set of electronic data to the fraud ring database, wherein the first set of electronic data includes a first fraud ring identifier and the second set of electronic data comprises a second fraud ring identifier.

In addition, in certain embodiments, the fraud ring investigation application is further configured to receive one or more documents related to the first or second fraud ring investigation, link the document(s) to the respective fraud ring identifier, and communicate the document to the fraud ring database for storage with the respective set of electronic data.

In various embodiments, the fraud ring investigation management system further includes a fraud ring investigator profile database that is configured to store an investigator profile associated with each of one or more investigators. Each investigator profile includes an investigator identifier unique to each investigator and access permissions. In certain embodiments, the fraud ring investigation application is further configured to: (1) receive electronically via the communications network the first set of electronic data from the computing device being used by the first investigator, wherein the first set of electronic data comprises a first investigator identifier identifying the first investigator; (2) in response to receiving the first set of electronic data, retrieve a first investigator profile associated with the first investigator identifier; (3) compare, via a computer processor, access permissions of the first investigator profile with an action requested by the first investigator; (4) in response to the action requested by the first investigator being allowed per the access permissions of the first investigator profile, permit the action requested; and (5) in response to the action requested by the first investigator not being allowed per the access permissions of the first investigator profile, generate, via the computer processor, a notification indicating that the action is not allowed and communicate the notification to the computing device. In certain embodiments, the action requested by the first investigator includes one or more of: saving the first set of electronic data or editing the first set of electronic data.

According to various embodiments, the fraud ring investigation application is also configured to: (1) receive one or more search terms from an investigator computing device; (2) in response to receiving the one or more search terms, identify, via a computer processor, a first set of electronic data associated with a first fraud ring investigation stored in the fraud ring database that includes the one or more search terms; and (3) in response to identifying the first set of electronic data, generating, via the computer processor, a first hyperlink displayable by the investigator computing device, the first hyperlink being selectable to view at least a portion of the first set of electronic data. In certain embodiments, the fraud ring investigation application is further configured to: (1) in response to receiving the one or more search terms, identify, via the computer processor, a second set of set of electronic data associated with a second fraud ring investigation stored in the fraud ring database that includes the one or more search terms; and (2) in response to identifying the second set of electronic data, generating, via the computer processor, a second hyperlink displayable by the investigator computing device, the second hyperlink being selectable to view at least a portion of the second set of electronic data.

The fraud ring investigation application, according to a further embodiment, is also configured to: (1) receive a selection of the first hyperlink or the second hyperlink from the investigator computing device; (2) in response to receiving the selection of the first hyperlink, communicate at least a portion of the first set of electronic data to the investigator computing device; and (3) in response to receiving the selection of the second hyperlink, communicate at least a portion of the second set of electronic data to the investigator computing device. In a particular embodiment, the first hyperlink includes hypertext comprising the first fraud ring identifier, and the second hyperlink includes hypertext comprising the second fraud ring identifier. In addition, according to one embodiment in which one or more first documents associated with the first fraud ring investigation are linked to the first fraud ring identifier in the fraud ring database and one or more second documents associated with the second fraud ring investigation are linked to the second fraud ring identifier in the fraud ring database, the fraud ring investigation application is further configured to: (1) in response to receiving a selection of the first hyperlink, generate and communicate first document hyperlinks associated with each of the one or more first documents to the investigator computing device, the first document hyperlinks being displayable by the investigator computing device, and (2) in response to receiving a selection of the second hyperlink, generate and communicate second document hyperlinks associated with each of the one or more second documents to the investigator computing device, the second document hyperlinks being displayable by the investigator computing device.

According to various other embodiments, a computer-implemented method of documenting a fraud ring investigation includes: (1) generating, via a computer processor, a fillable form displayable to a user via a computing device, the fillable form comprising one or more fields for receiving data related to a fraud ring investigation; (2) receiving a first set of data into the fillable form via the computing device, the first set of data being related to a first fraud ring investigation and the first set of data comprising (a) a first fraud ring identifier and (b) one or more fraud elements related to the first fraud ring investigation; and (3) in response to receiving the first set of data, storing the first set of data in a memory. The computer-implemented method, according to certain embodiments, further includes: (1) in response to storing the first set of data, generating, via a computer processor, a first electronic message confirming that the first set of data has been received; and (2) communicating the first electronic message to the computing device, the first electronic message being displayable by the computing device. In a particular embodiment in which the first electronic message includes a first hyperlink, the method further includes: (1) receiving a selection of the first hyperlink from the computing device via the communication network; (2) in response to receiving the selection of the first hyperlink, retrieving at least a portion of the first set of data stored in the memory; and (3) communicating the at least a portion of the first set of data to the computing device, the at least a portion of the first set of data being displayable by the computing device.

In one embodiment, the computer-implemented method further includes: (1) receiving one or more electronic documents related to the first fraud ring; (2) linking, via the computer processor, the one or more electronic documents related to the first fraud ring with the first fraud ring identifier; and (3) storing the one or more electronic documents related to the first fraud ring in the memory.

In addition, according to another embodiment, the computer-implemented method further includes: (1) receiving a second set of data into the fillable form via the computing device, the second set of data being related to a second fraud ring investigation and the second set of data including: (a) a second fraud ring identifier and (b) one or more fraud elements related to the second fraud ring investigation; and (2) in response to receiving the second set of data, storing the second set of data in the memory. In a further embodiment, the computer-implemented method includes generating, via the computer processor, a second electronic message confirming that the second set of data has been received in response to storing the second set of data. The second electronic message includes a second hyperlink, and the second hyperlink is selectable by the user of the computing device to view at least a portion of the second set of data.

In alternative embodiments, the second set of data may be received into the fillable form via a second computing device. According to certain embodiments, the computer-implemented method further comprises: (1) generating, via the computer processor, a first hyperlink comprising hypertext comprising the first fraud ring identifier and a second hyperlink comprising hypertext comprising the second fraud ring identifier, the first and second hyperlinks being displayable on the first computing device and the second computing device; (2) in response to receiving a selection of the first hyperlink from the first computing device, retrieving at least a portion of the first set of data for communicating to the first computing device; (3) in response to receiving a selection of the second hyperlink from the first computing device, retrieving at least a portion of the second set of data for communicating to the first computing device; (4) in response to receiving a selection of the first hyperlink from the second computing device, retrieving at least a portion of the first set of data for communicating to the second computing device; and (5) in response to receiving a selection of the second hyperlink from the second computing device, retrieving at least a portion of the second set of data for communicating to the second computing device. In a further embodiment, the computer-implemented method also includes: (1) in response to receiving a selection of the second hyperlink from the first computing device, retrieving access permissions associated with an investigator using the first computing device, the access permissions indicating whether the investigator may view at least a portion of the second set of data; (2) in response to the retrieved access permissions indicating that the investigator may view at least a portion of the second set of data, communicating the at least a portion of the second set of data to the first computing device, the second set of data being displayable by the first computing device; and (3) in response to the retrieved access permissions indicating that the investigator may not view at least a portion of the second set of data, generating, via the computer processor, an electronic message indicating that access is not granted and communicating the electronic message to the first computing device, the electronic message being displayable by the first computing device. Similarly, the computer-implemented method may also include: (1) in response to receiving a selection of the first hyperlink from the second computing device, retrieving access permissions associated with an investigator using the second computing device, the access permissions indicating whether the investigator may view at least a portion of the first set of data; (2) in response to the retrieved access permissions indicating that the investigator may view at least a portion of the first set of data, communicating the at least a portion of the first set of data to the second computing device, the at least a portion of the first set of data being displayable by the second computing device; and (3) in response to the retrieved access permissions indicating that the investigator may not view at least a portion of the first set of data, generating, via the computer processor, an electronic message indicating that access is not granted and communicating the electronic message to the second computing device, the electronic message being displayable by the second computing device.

According to certain embodiments, the computer-implemented also includes: (1) after storing the first set of data, receiving a third set of data into the fillable form, the third set of data being related to the first fraud ring investigation; (2) in response to receiving the third set of data, linking, via the computer processor, a subsequent version indicator with the third set of data, the subsequent version indicator indicating that the third set of data was received after the first set of data; and (3) storing the third set of data and the subsequent version indicator in the memory.

According to yet another alternative embodiment, a computer program product for documenting fraud ring investigations in an enterprise environment includes a non-transitory computer-readable medium having computer-readable program instructions stored therein. The computer-readable program instructions include: (1) first instructions configured for generating a fillable form for electronically receiving data related to a fraud ring investigation; (2) second instructions configured for communicating the fillable form to a first fraud ring investigator, the fillable form being displayable on a computing device used by the first fraud ring investigator; (3) third instructions configured for electronically receiving a first set of data into the fillable form, the first set of data related to a first fraud ring investigation being conducted by the first fraud ring investigator; and (4) fourth instructions configured for electronically storing the first set of data related to the first fraud investigation in a memory. In a further embodiment, the computer-readable program instructions further include: (1) fourth instructions configured for receiving one or more documents related to the first fraud ring investigation; and (2) fifth instructions configured for linking the one or more documents related to the first fraud investigation to the first set of data.

### BRIEF DESCRIPTION OF THE DRAWINGS

Having thus described embodiments of the invention in general terms, reference may now be made to the accompanying drawings:

FIG. 1 is a flow diagram illustrating an exemplary fraud ring investigation process according to one embodiment of the invention;

FIG. 2 illustrates a network environment in which the processes described herein are implemented, according to one embodiment of the invention;

FIG. 3 is a block diagram of a fraud ring investigation management server, in accordance with one embodiment of the present invention;

FIG. 4 is a block diagram of a database server, in accordance with an embodiment of the present invention;

FIG. 5 is a flow diagram of steps executed by a documentation module, in accordance with an embodiment of the present invention;

FIG. 6 is a flow diagram of steps executed by an access control module, in accordance with an embodiment of the present invention;

FIG. 7A is a flow diagram of steps executed by a version control module, in accordance with an embodiment of the present invention;

FIG. 7B is a flow diagram of steps executed by a version control module, in accordance with an alternative embodiment of the present invention;

FIG. 8 is a flow diagram of steps executed by a search module, in accordance with an embodiment of the present invention;

FIG. 9 is a flow diagram of steps executed by a data retrieval module, in accordance with an embodiment of the present invention;

FIG. 10 is a flow diagram of steps executed by an investigative tools module, in accordance with an embodiment of the present invention;

FIG. 11 is a flow diagram of steps executed by a communication module, in accordance with an embodiment of the present invention;

FIG. 12 is a flow diagram of steps executed by a tracking module, in accordance with an embodiment of the present invention;

FIG. 13 is a flow diagram of steps executed by a reporting module, in accordance with an embodiment of the present invention; and

FIGS. 14 through 25C are illustrations of exemplary graphical user interfaces and documents visible to an investigator conducting a fraud ring investigation by means of a fraud ring investigation management system in accordance with one embodiment of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

### Brief Summary

Embodiments of the present invention provide a unique fraud ring investigation management system that allows for the documentation and sharing of information related to one or more fraud ring investigations, which advantageously causes the processes implemented by and through the system to be significantly more efficient than those of the prior art.

According to various embodiments, the system provides a centralized workspace for documenting and sharing organized fraud ring intelligence and accessing ring investigation tools and various security resources. In certain embodiments, the system provides a web-based application accessible by fraud ring investigators via networked computing devices. Investigators use the application to enter data and store documents related to fraud ring investigations, to search for data and documents related to fraud ring investigations, and to access various fraud ring investigation tools and security resources. As used herein, unless otherwise noted, the term “investigators” refers to investigators, their managers, and administrators of the fraud ring investigation management system. As background, certain financial institutions may have groups of fraud investigators assigned to different investigative units within the financial institution. For example, a group of case investigators may be assigned to a local or regional investigative services field unit, which is generally tasked with investigating individual cases of fraud reported to the financial institution within a respective geographic location, and another group of investigators may be assigned to a ring investigation unit, which is generally tasked with investigating fraud rings that include multiple cases of fraud. The ring investigation unit may further divide its investigators into groups that investigate fraud rings operating in a certain geographical area or affecting customers in a certain geographical area. When field investigators suspect that one or more cases are part of a fraud ring or when a referral source outside of the financial institution's investigative services units is suspicious of possible fraud ring activity affecting the financial institution, the ring investigation unit is notified of the suspicious activity. The ring investigation unit researches the suspected activity, and if the suspected activity is determined to be part of a fraud ring, a ring investigator within the ring management unit documents the fraud ring via the fraud ring investigation management system.

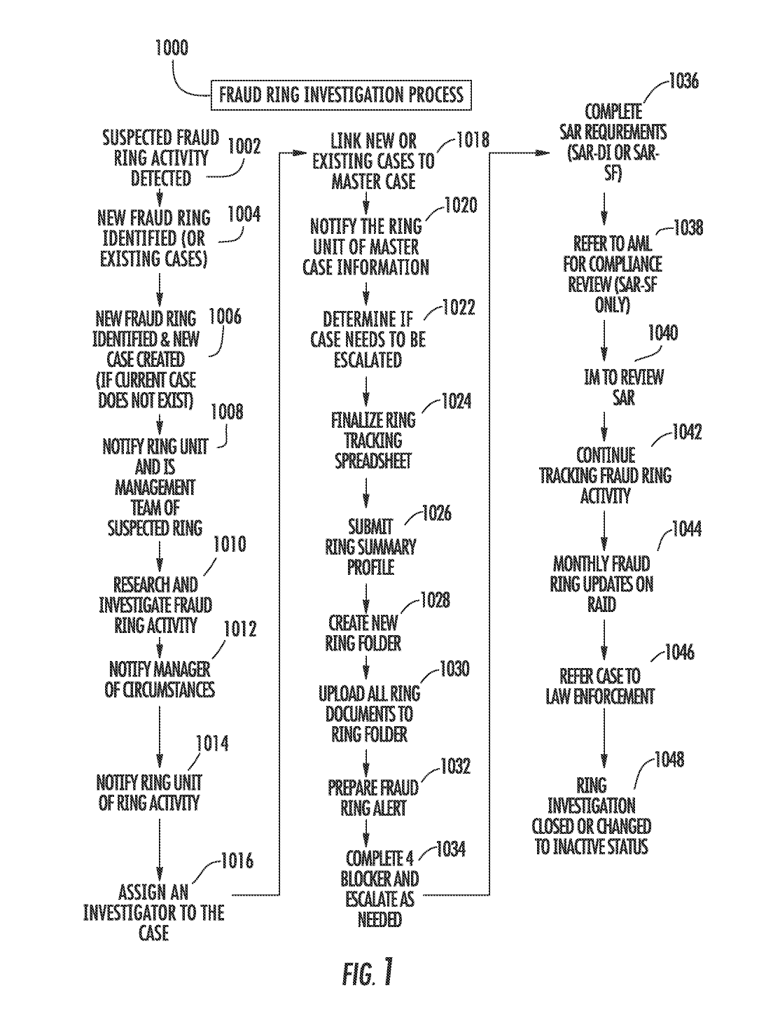

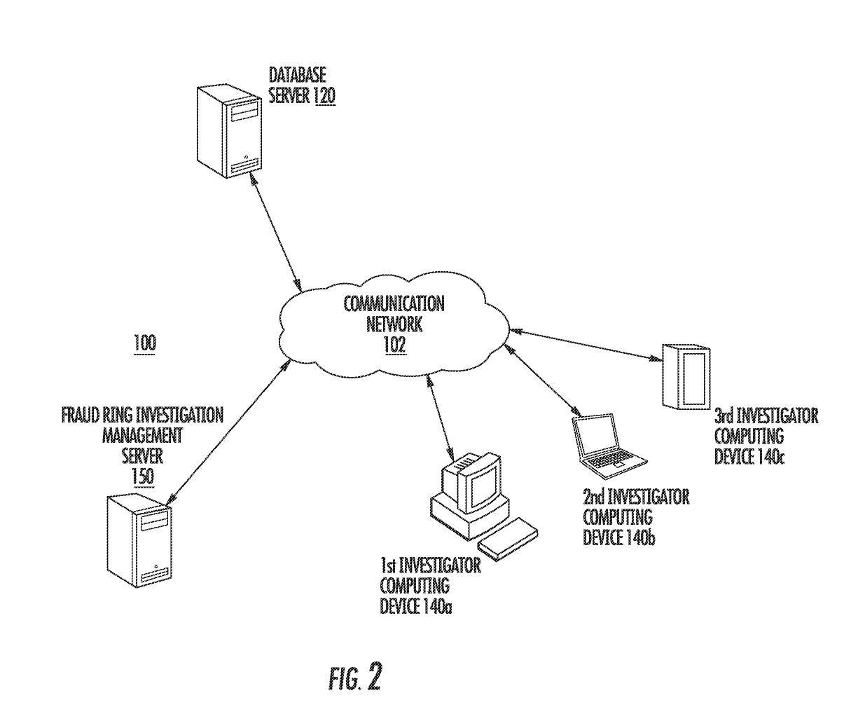

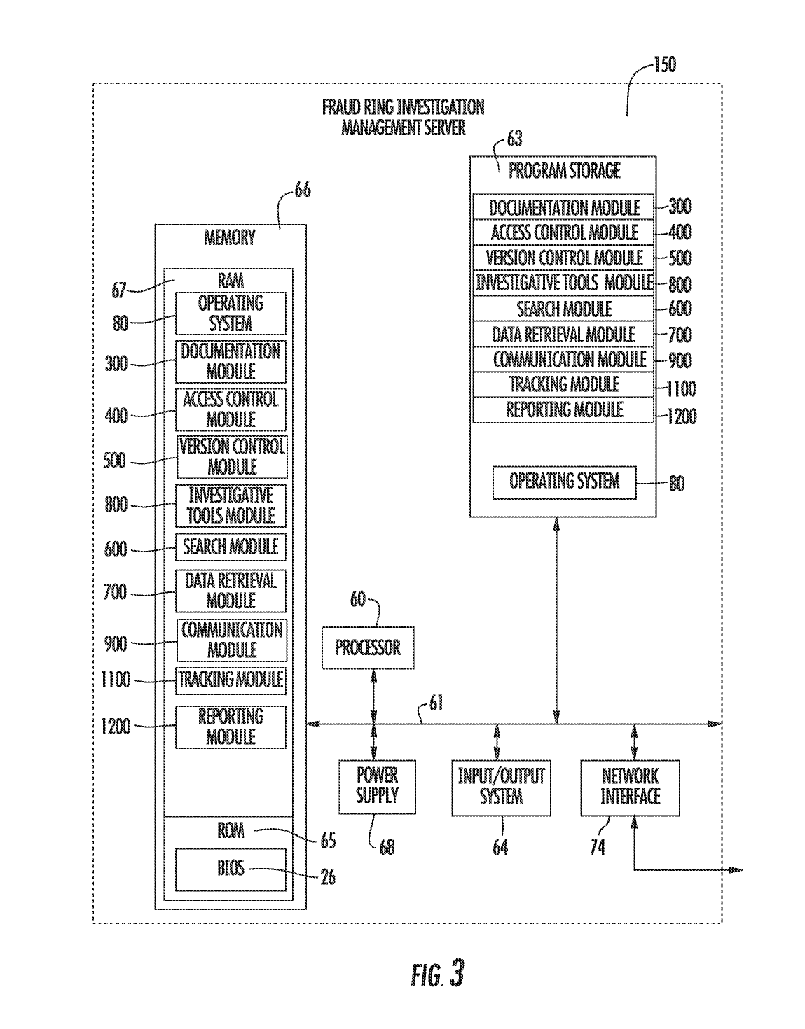

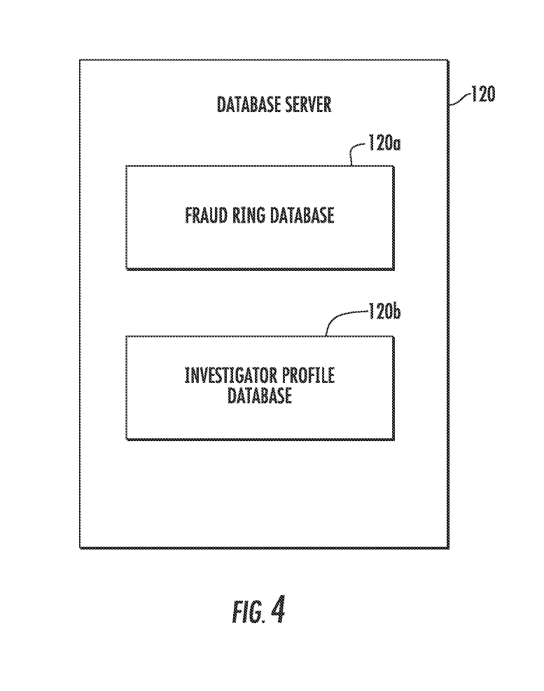

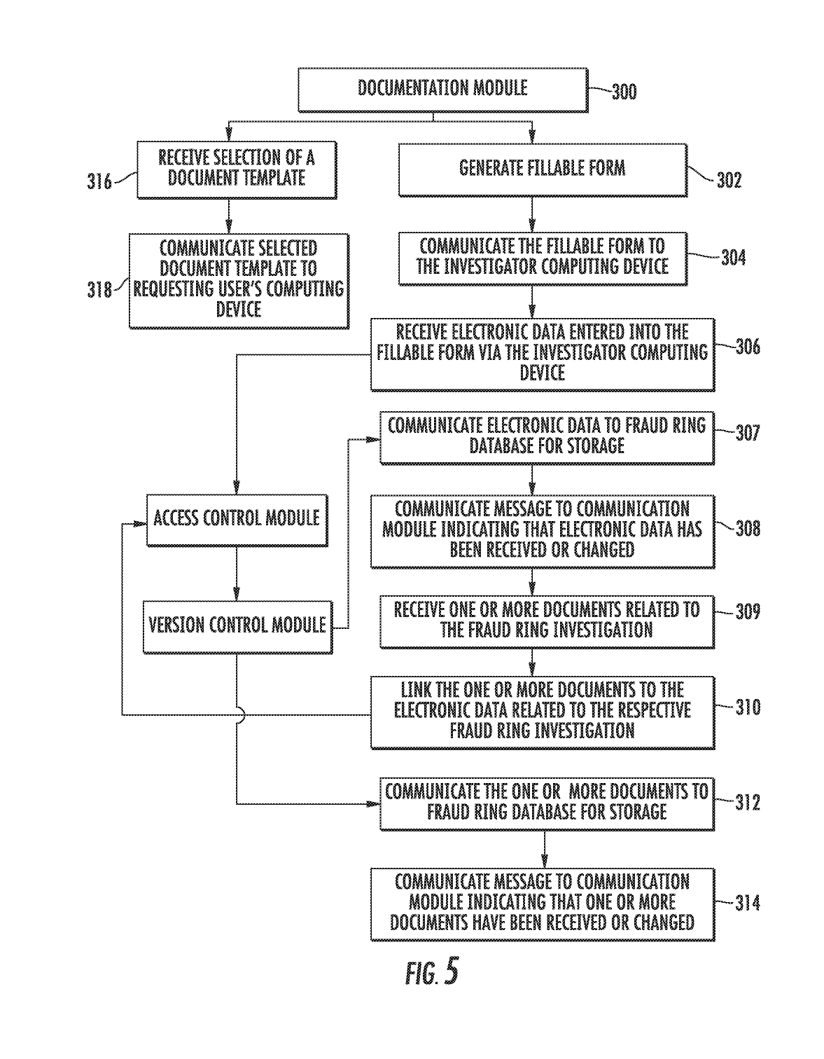

FIG. 1, described below, illustrates a flow diagram of an exemplary process of conducting a fraud ring investigation according to an embodiment of the invention. FIGS. 2 and 3 illustrate the architecture of an exemplary system for documenting and managing fraud ring investigations, according to one embodiment of the invention. FIG. 4 illustrates a block diagram of a database server for storing data related to fraud ring investigations, according to one embodiment. FIGS. 5 through 13 illustrate various flow charts of steps performed by modules of the fraud ring investigation management system during the documentation and management processes of the fraud ring investigation, according to various embodiments of the invention. These figures are described in more detail below.

### Exemplary Flow of Fraud Ring Investigation Process

FIG. 1 illustrates a flow diagram of an exemplary process 1000 of a fraud ring investigation process according to one embodiment of the invention. Beginning at Step 1002, the fraud ring investigation process begins when suspected fraud ring activity is detected by a case investigator, other investigator within the financial institution, or other referral source (e.g., line of business partner). Next, at Step 1004, if the suspected fraud ring activity identified in Step 1002 is new, the new fraud ring case is referred to the ring investigation unit from the case management unit. Then, at Step 1006, the ring investigator identifies the suspected ring activity as a new fraud ring or as part of an existing fraud ring after researching the suspected activity. In addition, in some embodiments (not shown), other investigators may receive notification that the newly identified fraud ring involves one of their cases. At Step 1008, the ring investigator then notifies the ring investigation unit and an investigative services management team of the suspected activity. In particular, the ring investigator reviews the activity and supporting documentation with the ring investigation management team and manager for validation.

In Step 1010, after a fraud ring has been identified, if necessary, the ring investigator secures all supporting documentation and conducts research to identify common fraud elements linking all related cases, if necessary. Then, in Step 1012, the ring investigator discusses the circumstances of the fraud ring activity with the investigation services management team. In Step 1014, the ring investigation unit is notified of the identified fraud ring, and the ring investigator discusses with the ring investigation unit the intelligence regarding the fraud ring and next steps in the investigation.

Next, in Step 1016, a lead ring investigator is assigned to the ring investigation. According to one embodiment, the lead ring investigator is responsible for being the internal and external point of contact with issues related to the fraud ring, coordinating among other individual ring investigators to ensure all information is captured and updated appropriately in the fraud ring investigation management system, providing monthly updates regarding the fraud ring investigation, escalating information about the fraud ring within the ring investigation unit when appropriate, and being the primary contact for law enforcement officials.

The lead ring investigator then, in Step 1018, links new or existing cases to the master case. In particular, the lead ring investigator may consult with the ring investigation unit and the investigative services management team to determine if there are any new or existing fraud cases that should be linked to a master case for all cases related to the fraud ring investigation.

Next, in Step 1020, the lead ring investigator notifies the ring management unit of the master case information. Specifically, according to one embodiment, the investigator provides the following information about the ring investigation: (1) name of the ring, (2) whether it is a local, regional, or national ring, (3) the method of operation of the ring, (4) name of the lead investigator coordinating the investigation, and (5) a master case identifier (e.g., number) associated with the ring.

Then, in Step 1022, after the details of the fraud ring investigation have been identified, the lead investigator determines if the fraud ring needs to be escalated within the organization and/or to line of business partners. If the ring case needs to be escalated, the lead investigator, according to one embodiment, works with the ring investigation unit to prepare a fraud ring alert for sending to line of business partners potentially affected by the fraud ring activity and escalates the information within the investigation unit as necessary.

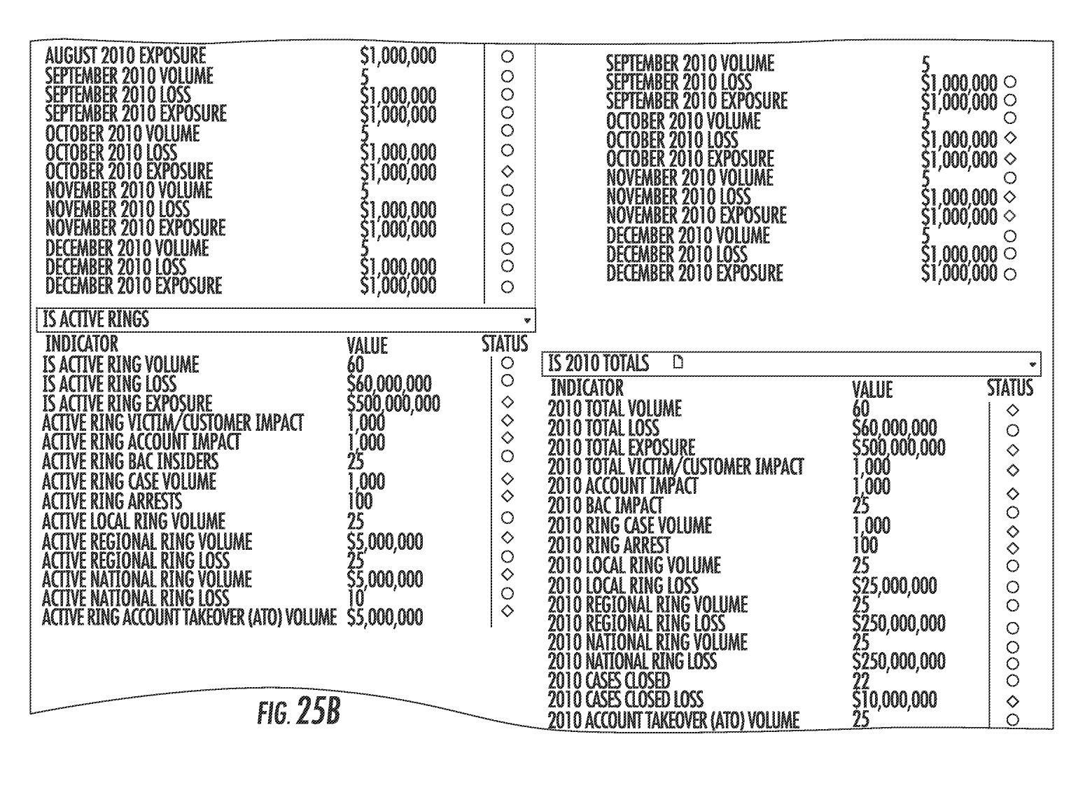

In Step 1024, the lead investigator then finalizes a ring tracking document (e.g., a spreadsheet), which captures key pieces of information related to the identified fraud ring, including customers, suspects, loss information, etc. FIG. 24B illustrates a partial view of an exemplary ring tracking spreadsheet template according to one embodiment, and FIG. 24A illustrates an index for certain categories included the ring tracking spreadsheet, according to one embodiment of the invention. The index lists various column headings included in one embodiment of the ring tracking spreadsheet and the definitions and/or possible values to be included in these columns. In some embodiments, the individual case investigators populate the ring tracking document with information related to their cases, and the lead ring investigator is responsible for maintaining the document (e.g., ensuring data therein is current and all-inclusive of the cases identified as part of the fraud ring). According to a particular embodiment of the invention, the ring tracking document includes the ring name and the date the ring was identified, and for each individual case associated with the ring investigation, the following types of information are included: transaction date, case number, investigator, account information for the affected account (e.g., name, social security or tax identification number, date of birth, account number, account balance, account status (e.g., open or closed), fraud type (e.g., account takeover, card not present, counterfeit, fraud credit card application, lost/stolen card, card never received, new account fraud, check fraud, taking advantage of the account, customer taking advantage of the account), credit limit on credit card, loss exposure or fraud claims amount, loss prevention amount), research strategist account elements (e.g., product (e.g., checking account, savings account, consumer credit card, business credit card, debit card), product type, ANI number (e.g., calls that are made on the account), whether identification was presented during transaction, type of identification presented, fraud phone number associated with the account, priority plate request (e.g., card sent overnight), fraud/alternative address, email address, IP address, authorized user/secondary name, employer name), transaction level detail (e.g., merchant name, merchant identification number, SIC code (e.g., four digit code identifying the type of transaction), point of sale device (e.g., was a card swiped or keyed), common point of purchase (CPP) name, type of payment (e.g., ACH, check), routing number for bank, maker's name, payee's name, name on payment, method of payment, type of change to account information (e.g., address, phone number, mother's maiden name), date of change, whether online access was changed, and date of online access change), suspect information (e.g., suspect name/nickname/description, social security or tax identification number, address, city/state), and any comments related to the investigation that should be noted.

Next, in Step 1026, the lead investigator accesses the fraud ring investigation management system via a networked computing device. According to certain embodiments, the lead investigator utilizes the ring tracking document to identify summary profile data related to the fraud ring (e.g., the name of the fraud ring, the number of customers and accounts affected, the line of business partners that may be affected, the amount of loss and/or exposure) and enters the summary profile data into a new ring submission form generated by the fraud ring investigation management system. An exemplary process according to various embodiments for generating and communicating this form is discussed below in relation to FIG. 5, and an exemplary graphical user interface according to one embodiment that illustrates this form is discussed below in relation to FIG. 15. According to various embodiments, the summary profile data entered into the new ring submissions form may be accessed or exported into another computer application (e.g., MS Excel or MS Word) to provide investigators with a brief summary of data related to the fraud ring investigation.

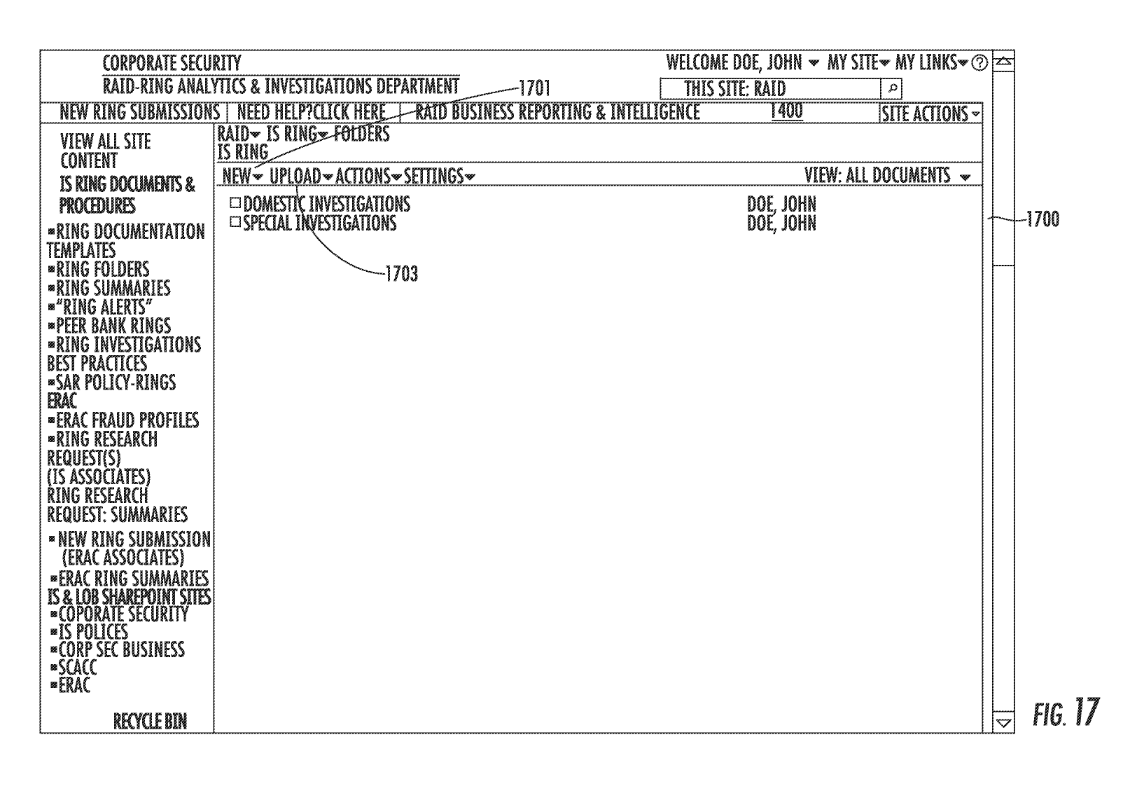

A folder for storing documents supporting and related to the fraud ring investigation is then created within the fraud ring investigation management system, as shown in Step 1028, and documents are uploaded to the folder by the investigator, as shown in Step 1030. Exemplary documents include the ring tracking document, a 4-blocker form (e.g., the 4-blocker form shown in FIG. 20), the alert(s) sent to line of business partners (e.g., the alert document shown in FIG. 21) in Step 1022, suspect photo(s), and all other relevant supporting documents. In addition, an exemplary graphical user interface for creating folders and uploading documents thereto according to one embodiment is described below in relation to FIG. 17.

Then, in Step 1032, if necessary, the lead investigator prepares a fraud ring alert, and if necessary, escalates the alert to his/her manager or to the ring investigation unit for distribution. Also, in Step 1034, if necessary, the lead investigator escalates the 4-blocker document to his/her manager or the ring investigation unit for distribution. For example, in various embodiments, the 4-blocker document may need to be escalated in response to the following situations: (1) the fraud ring attracts media attention, (2) a systemic or wide spread issue has been identified, (3) the fraud ring affects a process or procedure that exposes the financial institution's customer(s) or line of business partner(s) to present or future risk, (4) the fraud ring presents an increased risk of monetary exposure, (5) a suspected member(s) of the fraud ring is an employee of the financial institution, or (6) the fraud ring presents a regulatory or reputational risk to the financial institution.

In Step 1036, the lead investigator completes all Suspicious Activities Report (SAR) requirements (e.g., as required by 31 CFR 103.18-103.22), including satisfying all Suspicious Activities Report by a Depository Institution (SAR-DI)) and Suspicious Activities Report by Securities and Futures Industries (SAR-SF) filing guidelines. Then, in Step 1038, if it is an SAR-SF matter, the investigator refers the matter to an anti-money laundering (AML) compliance partner for further review. In Step 1040, the investigator submits the SAR to his/her manager for final approval.

In Step 1042, the lead investigator continues tracking fraud ring activity. In particular, according to one embodiment, the investigator coordinates among the individual case investigators to ensure that all additional ring related cases are captured within the ring tracking documents and ring summary profile in the fraud ring investigation management system. In addition, as shown in Step 1044, the investigator prepares a ring update summary periodically and submits the summary to the investigation management system. The update summary, according to certain embodiments, reflects the date the summary was created and includes any changes from the previous summary related to loss, exposure, arrests, changes in modus operandi, suspect identification, new cases identified as part of the fraud ring, geographic impact, and primary fraud channels, for example. The summary may be created yearly, bi-yearly, quarterly, monthly, bi-monthly, or weekly, for example. All relevant documentation is also updated as needed. In a particular embodiment, the summary should be updated monthly if the fraud ring is currently active.

In Step 1046, the lead investigator refers the ring case to law enforcement. In particular, the lead investigator contacts the appropriate law enforcement agency for further investigation and prosecution after all ring documentation has been secured and the relationships among various cases have been documented. Then, at Step 1048, when information is received indicating that a ring is no longer active or when the ring is no longer affecting the financial institution and its customers for a certain period of time (e.g., six months, year, etc.), the fraud ring investigation is closed or changed to inactive status.

In alternative embodiments (not shown), the lead investigator does not prepare a ring tracking document as described above in relation to Step 1024. Instead, the lead investigator and/or individual case investigators enter data into the fraud ring investigation management system directly. This data (or a portion thereof) may then be exported into another computer application (e.g., MS Excel or MS Word) to create the ring summary profile document that includes at least a portion of the data.

In Steps 1002 through 1048 described above, the fraud ring investigation management system is utilized to document and track information related to fraud ring investigations. An exemplary architecture of the system and flows of various functions of the system are described below, according to certain embodiments of the invention.

### System Architecture

FIG. 2 illustrates an exemplary fraud ring investigation management system 100 in accordance with an embodiment of the invention. In some embodiments, the environment of the fraud ring investigation management system 100 is the information technology platform of an enterprise, for example a national or multi-national corporation, and includes a multitude of servers, machines, and network storage devices in communication with one another over a communication network. In particular, a fraud ring investigations management server 150, at least one database server 120, and one or more investigator computing devices 140a, 140b, 140c (e.g., enterprise personal computers) are all in communication over a communication network 102. The communication network 102 may be a wide area network, including the Internet, a local area network or intranet, a wireless network, or the like.

FIG. 3 is a schematic diagram of the fraud ring investigations management server 150 according to various embodiments. The fraud ring investigations management server 150 includes one or more computer processors 60 that communicate with other elements within the fraud ring investigations management server 150 via a system interface or bus 61. Also included in the fraud ring investigations management server 150 are one or more display device/input devices 64 for receiving and displaying data. This display device/input device 64 may be, for example, a keyboard, pointing device, and/or touchpad that is used with a monitor. The fraud ring investigations management server 150 further includes memory 66, which preferably includes both read only memory (ROM) 65 and random access memory (RAM) 67. The server's ROM 65 is used to store a basic input/output system 26 (BIOS), containing the basic routines that help to transfer information between elements within the fraud ring investigations management server 150.

In addition, the fraud ring investigations management server 150 includes at least one storage device 63, such as a hard disk drive, floppy disk drive, a CD ROM drive, or optical disk drive, for storing information on various computer-readable media, such as a hard disk, a removable magnetic disk, or a CD ROM disk. As will be appreciated of one of ordinary skill in the art, each of these storage devices 63 is connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, a documentation module 300, an access module 400, a version control module 500, a search module 600, a data retrieval module 700, an investigative tools module 800, a communication module 900, a tracking module 1100, and a reporting module 1200. According to various embodiments, the documentation module 300, the access module 400, the version control module 500, the search module 600, the data retrieval module 700, the investigative tools module 800, the communication module 900, the tracking module 1100, and the reporting module 1200 control certain aspects of the operation of the fraud ring investigation management server 150 with the assistance of the processor 60 and the operating system 80. In general, the documentation module 300 is configured to allow investigators to document fraud ring investigations by receiving and storing data describing various aspects of the fraud ring investigation and receiving and storing documents that support the investigation. The access module 400 is configured to confirm whether an investigator accessing the system 100 has permission to perform the action requested (e.g., view or edit) by the investigator to protect sensitive information and prevent unauthorized access to data related to certain fraud ring investigations. The version control module 500 is configured to track versions of data entered into the fraud ring investigation management system 100. The data retrieval module 600 is configured to receive a request to retrieve data and/or documents associated with a fraud ring investigation and communicate the retrieved data and/or document to the investigator computing device 140a, 140b, 140c. The investigative tools module 800 is configured to provide hyperlinks for accessing investigative tools to assist investigators in conducting their investigations, and the communications module 900 is configured to generate messages indicating whether data and/or documents have been newly added or changes, generate announcements for displaying to all investigators, and allow chatting among investigators. The tracking module 1100 is configured to generate and communicate a calendar listing deadlines related to fraud ring investigations assigned to a particular investigator and assign tasks to other investigators. The reporting module 1200 assist users of the system 100 with managing and reporting data related to one or more fraud ring investigations, such as creating summary report templates listing fraud ring summary data to be included in each of one or more types of reports and creating summary reports using the report templates and the fraud ring summary profile data associated with each of one or more fraud ring investigations. Embodiments of these modules are described in detail below in relation to FIGS. 5 through 13. In certain embodiments, these program modules 300, 400, 500, 600, 700, 800, 900, 1100, 1200 are executed by the fraud ring investigation management server 150 and are configured to generate graphical user interfaces accessible to users via the Internet or other communications network. For example, in one particular embodiment, at least a portion of the modules are part of a web-based document management system, such as MICROSOFT SHAREPOINT, stored locally on and executed by the fraud ring investigation management server 150. In other embodiments, one or more of the modules 300, 400, 500, 600, 700, 800, 900, 1100, 1200 may be stored locally on the investigators' investigator computing devices 140a, 140b, 140c and executed by one or more processors of the computing devices 140a, 140b, 140c.

According to various embodiments, the modules 300, 400, 500, 600, 700, 800, 900, 1100, 1200 may utilize data contained in the database server 120, and the database server 120 may include one or more separate, linked databases. For example, as shown in FIG. 4, the database server 120 according to various embodiments stores a fraud ring database 120a and an investigator profile database 120b, according to one embodiment of the invention. The fraud ring database 120a stores electronic data and documents related to each fraud ring investigation, and the investigator profile database 120b stores data related to access permissions for each investigator utilizing the fraud ring investigation management system 100. According to certain embodiments, each fraud ring investigation is assigned to a particular investigator, and the investigator profile associated with the assigned investigator is linked to the data associated with the fraud ring investigation. In particular, in one embodiment, a fraud ring identifier uniquely identifying the data related to a fraud ring investigation is linked to an investigator identifier uniquely identifying the investigator assigned to the fraud ring investigation. In some embodiments in which two or more investigators are assigned to a particular fraud ring investigation, the investigator identifiers of the two or more investigators are linked to the fraud ring identifier.

Also located within the fraud ring investigations management server 150 is a network interface 74, for interfacing and communicating with other elements of a computer network. It will be appreciated by one of ordinary skill in the art that one or more of the fraud ring investigation management server 150 components may be located geographically remotely from other fraud ring investigation management server 150 components. Furthermore, one or more of the components may be combined, and additional components performing the functions described herein may be included in the fraud ring investigations management server 150.

### Exemplary System Flow

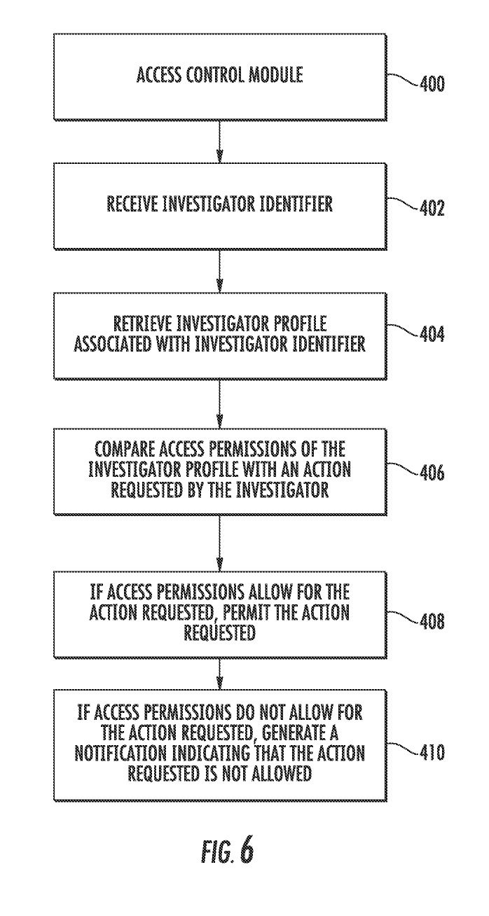

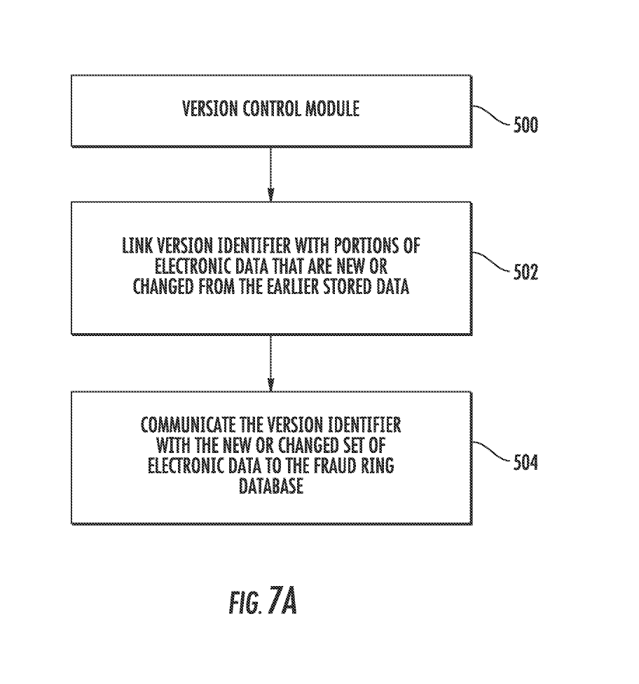

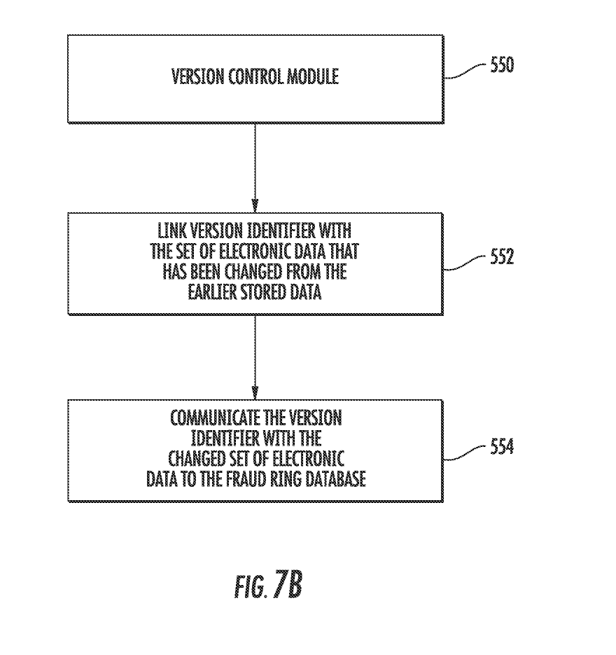

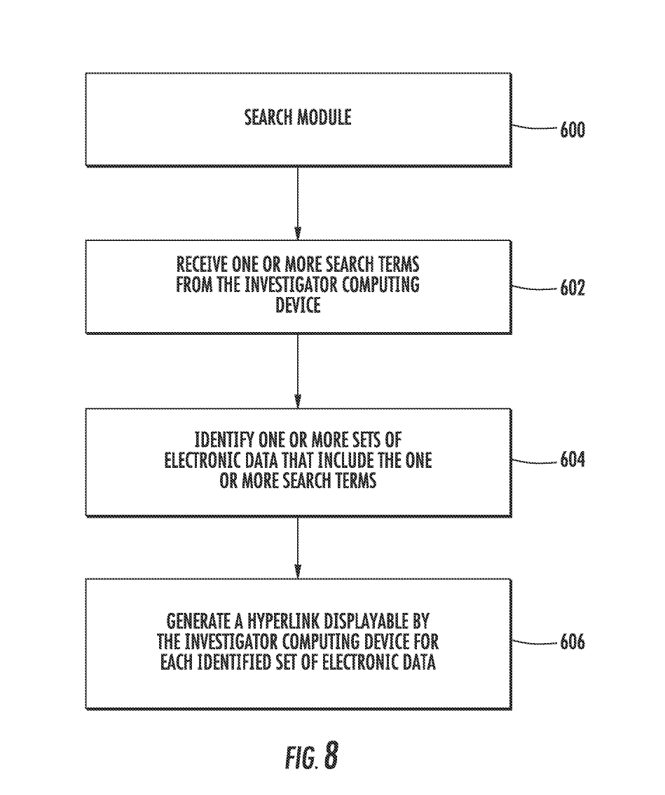

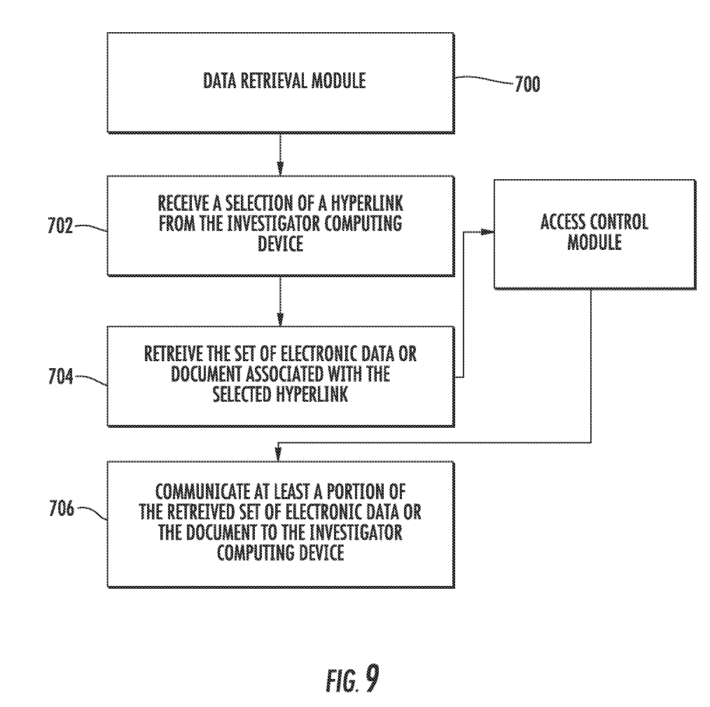

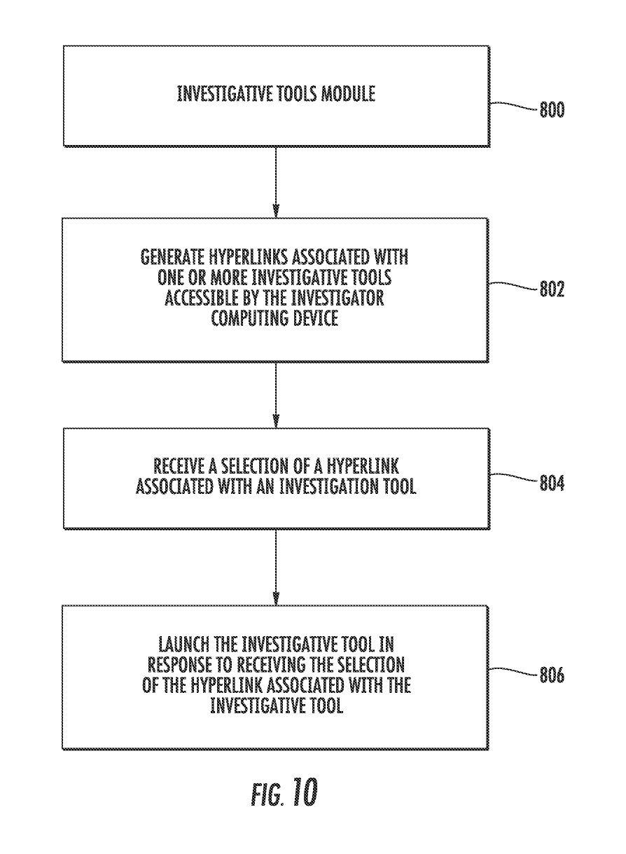

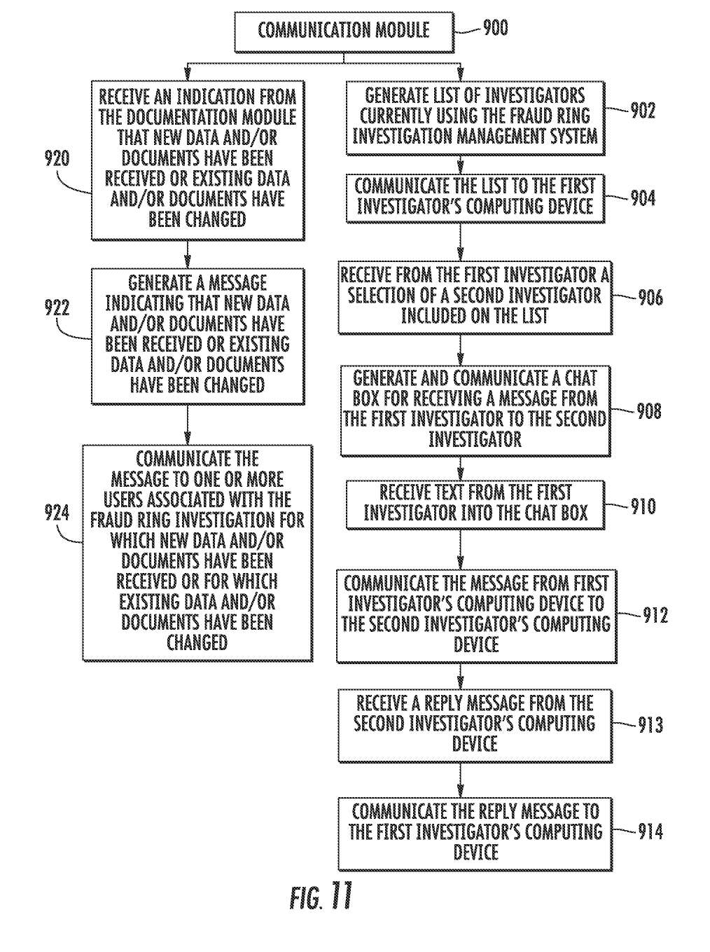

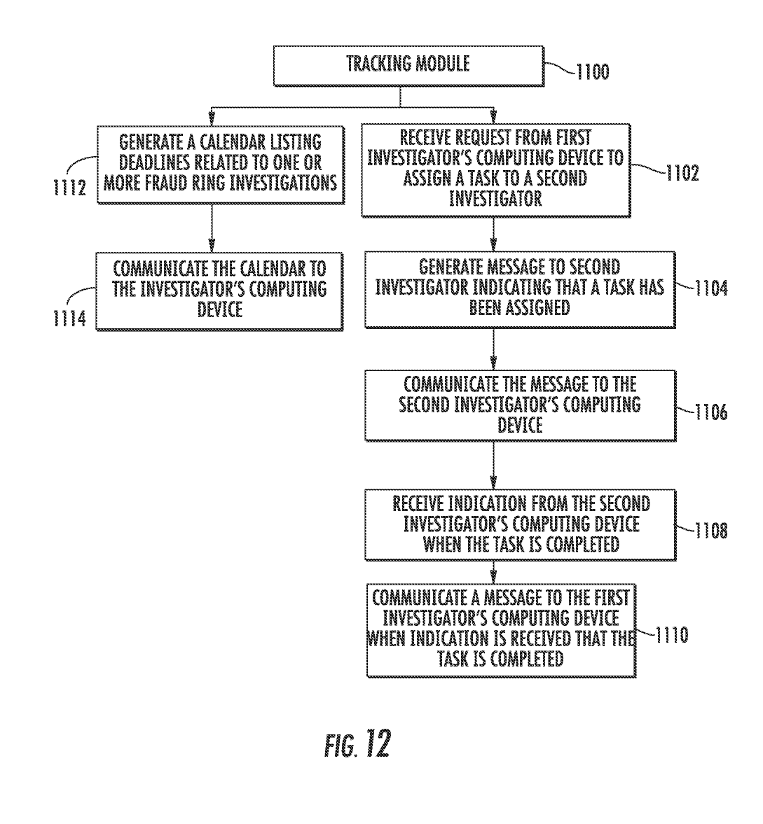

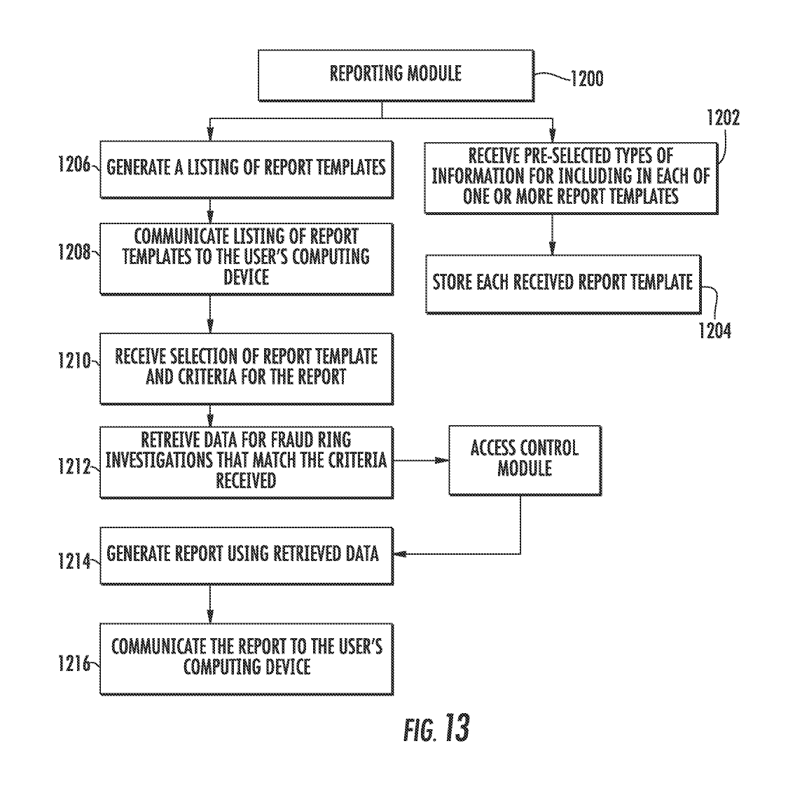

As described in more detail below, the fraud ring investigation management system 100 allows investigators to document fraud ring investigations via a documentation module (e.g., via the documentation module illustrated in FIG. 5), provides access control for investigators utilizing the system (e.g., via the access control module illustrated in FIG. 6), tracks versions of data entered into the system (e.g., via the version control modules illustrated in FIGS. 7A and 7B), allows for searching of data related to multiple ring investigations (e.g., via the search module illustrated in FIG. 8), allows for retrieval of data related to multiple ring investigations (e.g., via the data retrieval module illustrated in FIG. 9), provides various investigative tools useful for investigators conducting ring investigations (e.g., via the investigative tools module illustrated in FIG. 10), allows on-line chatting and provides automated notifications regarding new or changed data and/or documents associated with a fraud ring investigation (e.g., via the communication module illustrated in FIG. 11), allows tasks to be assigned to other investigators and generates calendars for each investigator listing deadlines associated with the fraud ring investigations assigned to the respective investigators (e.g., via the tracking module illustrated in FIG. 12), and allows report templates to be created, stored, and utilized to generate reports (e.g., via the reporting module illustrated in FIG. 13). Each of these modules is discussed in detail below.

Documentation Module

The documentation module of the system allows the user of the investigator computing device 140a, 140b, 140c to enter and edit data related to fraud ring investigations and create and upload documents related to fraud ring investigations. FIG. 5 illustrates a documentation module 300 according to various embodiments. Beginning at Step 302, the documentation module 300 generates a fillable form that includes various fields for receiving information related to a fraud ring investigation. For example, according to certain embodiments, the fillable form includes fields for receiving summary profile data related to the fraud ring, including, for example, the following: name and description of the fraud ring, loss amount, exposure amount, suspect name(s), arrests, modus operandi, cases identified as part of the fraud ring, geographic impact, primary fraud channels, and other fraud elements. In addition, in certain embodiments, the fillable form indicates which fields are required to be completed. A portion of an exemplary form according to one embodiment is shown in FIG. 15 and is discussed below. If data for the fraud ring investigation has been submitted to the system 100 previously, the documentation module 300 includes previously entered data in the fillable form generated in Step 302.

At Step 304, the documentation module 300 communicates the fillable form to the investigator computing device 140a, 140b, 140c. The fillable form is communicated electronically via the communication network, and when received by the investigator computing device 140a, 140b, 140c, the fillable form is displayable thereon. The investigator using the investigator computing device 140a, 140b, 140c enters and/or edits data related to the fraud ring investigation into the fillable form. In Step 306, the documentation module 300 receives electronic data entered into the fillable form via the investigator computing device 140a, 140b, 140c. Then, in Step 307, the module 300 communicates the received data to the fraud ring database 120a for storage. According to various embodiments, the documentation module 300 calls the access control module, such as the access control module 400 discussed below in relation to FIG. 6, before the data is communicated to the fraud ring database 120a to ensure that the investigator entering or editing the data has permission to do so. If the access control module permits the action requested, the documentation module 300 continues onto Step 307. In a further embodiment, the documentation module 300 also calls the version control module, such as the version control modules 500, 550 discussed below in relation to FIGS. 7A and 7B, respectively, before the data is communicated to the fraud ring database 120a to associate a version identifier with the data being stored. After the data is communicated to the fraud ring database 120a for storage, the documentation module 300 generates and communicates a message to the communication module, such as the communication module 900 discussed below in relation to FIG. 11, indicating that the data has been received or changed, which is shown as Step 308.

In Step 309, the documentation module 300 receives one or more documents related to the fraud ring investigation, and in Step 310, links the one or more documents to at least a portion of the electronic data associated with the respective fraud ring investigation. In one embodiment, the module 300 links the one or more documents to a fraud ring identifier unique to the fraud ring (e.g., fraud ring name, number, or alpha-numeric combination identifying the fraud ring). Then, at Step 312, the module 300 communicates the one or more documents to the fraud ring database 120a for storage. According to certain embodiments, the documents are stored in folders and/or are tagged with the fraud ring identifier to link them with the fraud ring investigation. As noted above with respect to the data received by the module 300, according to certain embodiments, the documentation module 300 calls the access control module before the one or more documents are communicated to the fraud ring database 120a to ensure that the investigator submitting the documents has permission to do so. If the access control module permits the action requested, then the documentation module 300 continues on to Step 312. In a further embodiment, the documentation module 300 also calls the version control module before the one or more documents are communicated to the fraud ring database 120a to associate a version identifier with the documents being stored. Finally, at Step 314, the module 300 communicates to the communication module a message indicating that one or more documents have been received by or changed within the system 100.

In addition, the documentation module 300 provides investigators with document templates to use in documenting investigations. In particular, beginning at Step 316, the documentation module 300 receives a selection of a document template from the investigator's investigator computing device 140a, 140b, 140c. In response, at Step 318, the module 300 communicates the selected document template to the investigator's investigator computing device 140a, 140b, 140c for display thereon. In certain embodiments, the document templates provided by the system 100 include, for example, the 4 Blocker document, the ring tracking document, and an alert document. Exemplary illustrations of some of these templates according to various embodiments are shown in FIGS. 20 and 21.

Access Control Module

To protect sensitive information and prevent unauthorized access (e.g., view or edit) to data related to certain fraud ring investigations, the system 100, according to various embodiments, includes an access control module that confirms whether the investigator accessing the system 100 has permission to perform the action requested by the investigator. For example, the access control module may be executed by the system 100 in response to receiving a request from the investigator computing device 140a, 140b, 140c to view data, save new data, or edit existing data related to one or more fraud ring investigations, prior to allowing the action requested. The permissions associated with each investigator may be set by a system administrator, according to certain embodiments of the invention.

FIG. 6 illustrates an access control module 400 according to various embodiments of the invention. The access control module 400 begins at Step 402 by receiving an investigator identifier. According to various embodiments, the investigator identifier may be a number, name, or alpha-numeric combination that uniquely identifies the investigator accessing the fraud ring investigation management system 100. In addition, according to certain embodiments, the investigator identifier is captured from the investigator's log in information into the investigator's investigator computing device 140a, 140b, 140c or another application (e.g., MS Outlook) running on the investigator's investigator computing device 140a, 140b, 140c.

Then, at Step 404, the module 400 retrieves an investigator profile associated with the investigator identifier. The investigator profile includes access permissions granted to the investigator. Next, at Step 406, the module 400 compares the access permissions of the investigator profile with an action requested by the investigator. Exemplary actions requested may include saving, editing, or viewing data related to one or more fraud ring investigations. If the access permissions allow for the action requested, the module 400 permits the action requested, as shown in Step 408. However, if the access permissions do not allow for the action requested, the module 400 generates a notification indicating that the action requested is not allowed, as shown in Step 410. According to various embodiments, the notification may be an email, a MMS, or a message displayable on the screen of the investigator computing device 140a, 140b, 140c.

Version Control Module

To track versions of data entered into the fraud ring investigation management system 100, the system 100 according to various embodiments includes a version control module. FIG. 7A illustrates a version control module 500 according to various embodiments of the invention. Beginning at Step 502, the version control module 500 links a version identifier with the specific data that is newly added or is modified from the earlier stored data. As an example, according to one embodiment, when the user changes a field on the ring summary profile form (e.g., changing the number of customers affected by the fraud ring or the amount of loss resulting from the fraud ring), a version identifier is associated with the newly added data. According to various embodiments, the version identifier may be a date/time stamp, a number, and/or an alpha-numeric combination that identifies the data as new or changed from the previously entered data. For example, according to various embodiments, the version identifier includes a date and time stamp indicating the date and time when the data was newly added or edited. As another example, in one embodiment, a version identifier such as “v2” is linked with the edited data after it is edited for the first time and “v3” is linked with the edited data after it is edited for the second time, and so on. At Step 504, the version control module 500 communicates the version identifier with the new or changed data to the fraud ring database 120a for storage.

FIG. 7B illustrates an alternative embodiment of the version control module 550. In this embodiment, the version control module 550 links the version identifier with the full set of electronic data in which one or more changes have been made from the earlier stored data, which is shown as Step 552. At Step 554, the version control module 550 communicates the version identifier with the new or changed set of electronic data to the fraud ring database 120a for storage. For example, in the embodiment shown in FIG. 15, a date and time stamp is displayed that indicates when the ring summary profile was created and when data in the ring summary profile was last modified.

Search Module

The search module allows the investigator to retrieve a listing of fraud ring investigations having data matching search criteria entered by the investigator. FIG. 8 illustrates a search module 600 according to various embodiments of the invention. The search module 600 begins at Step 602 by receiving one or more search terms from the investigator computing device 140a, 140b, 140c. Next, at Step 604, the module 600 identifies one or more sets of electronic data associated with respective fraud ring investigations that include the one or more search terms. Then, for each identified set of electronic data, the module 600 generates a hyperlink displayable by the investigator computing device 140a, 140b, 140c, as shown in Step 606. The hyperlink, according to various embodiments, may include hypertext that includes the name of the fraud ring investigation or other identifier for the fraud ring investigation. In addition, in various embodiments, the search module 600 also identifies documents and folders that include the one or more search terms and generates a hyperlink for each identified document and/or folder.

Data Retrieval Module

According to various embodiments, to view data and/or documents associated with a particular fraud ring investigation, the investigator selects a hyperlink associated with the data and/or documents that is displayed via the investigator computing device 140a, 140b, 140c. For example, hyperlinks such as those displayed in Step 606 of the search module 600 and hyperlinks for documents associated with a particular fraud ring investigation may be displayed by the investigator computing device 140a, 140b, 140c. The data retrieval module receives the selection, retrieves the data and/or document associated with the selected hyperlink, and communicates the retrieved data and/or document to the investigator computing device 140a, 140b, 140c.

FIG. 9 illustrates a data retrieval module 700 according to various embodiments of the invention. Beginning at Step 702, the data retrieval module 700 receives a selection of a hyperlink from the investigator computing device 140a, 140b, 140c. The module 700 then retrieves the set of electronic data and/or document associated with the selected hyperlink, which is shown at Step 704. According to various embodiments, the data retrieval module 700 calls the access control module, such as the access control module 400 discussed above in relation to FIG. 6, to ensure that the investigator requesting to view the data or document has permission to do so. If the access control module permits the action requested, then the data retrieval module 700 continues on to Step 706. At Step 706, the module 700 communicates at least a portion of the retrieved set of electronic data and/or document to the investigator computing device 140a, 140b, 140c.

Investigative Tools Module

During the course of the fraud ring investigation, the investigator may need to access internal and/or external investigative tools (e.g., applications or websites) to gather intelligence regarding fraud rings. According to various embodiments, these investigative tools include, for example, an application for tracking the contact information of former employees of the financial institution, an application used by bank tellers for entering transaction data, an application for verifying the identification of an employee of the financial institution, an application that generates reports about the activities of a particular employee or person over a particular time period, an application that allows checks to be viewed after they have been cashed, an application for tracking which computing devices access which accounts of the financial institution, an application for searching public records, and an application for conducting forensic analyses. The investigative tools module, according to various embodiments, generates hyperlinks to these tools and communicates the hyperlinks to the investigator computing devices 140a, 140b, 140c for display thereon, which provides a more centralized workspace for the investigators.

FIG. 10 illustrates an investigative tools module 800 according to various embodiments of the invention. The investigative tools module 800 generates one or more hyperlinks associated with one or more investigative tools accessible by the investigator computing device 140a, 140b, 140c, which is shown at Step 802. These hyperlinks are displayable by the investigator computing device 140a, 140b, 140c. The module 800 may then receive a selection of one of the investigative tools hyperlinks, which is shown at Step 804, and in response, the module 800 launches the selected investigative tool, which is shown at Step 806.

Communication Module

To facilitate communications among investigators and generate messages related to fraud investigations, the system 100 includes the communication module that, according to various embodiments, allows on-line chatting among investigators that are using the fraud ring investigation management system 100, generates messages to investigators and managers in response to receiving new data or documents or changes to existing data or documents related to fraud ring investigations, and generates announcements for displaying to the investigators on a home page of the fraud ring investigation management system 100.

In particular, FIG. 11 illustrates a communication module 900 according to various embodiments. To facilitate on-line chatting among investigators, the module begins at Step 902 by generating a list of investigators that are currently using the system and, in Step 904, communicating the list to the investigators' investigator computing devices 140a, 140b, 140c for display thereon. According to certain embodiments, the list includes hyperlinks for each investigator using the system, which are selectable for sending a message to a particular investigator. In a particular embodiment, each hyperlink includes hypertext of the respective investigator's name. A first investigator, which refers to the investigator wishing to initiate communication with another investigator (referred to in this discussion as the second investigator), selects the hyperlink associated with the second investigator to whom the first investigator wishes to send a message. The module 900 receives the selection from the first investigator in Step 906, and in Step 908, the module 900 generates and communicates a chat box to the first investigator's investigator computing device 140a, 140b, 140c for display thereon. The module 900 then receives text into the chat box in Step 910 and communicates the text to the second investigator's investigator computing device 140a, 140b, 140c for display thereon in Step 912. In Step 913, the module 900 receives a reply message from the second investigator's investigator computing device 140a, 140b, 140c and, in Step 914, communicates the reply message to the first investigator's investigator computing device 140a, 140b, 140c.

In addition, the communication module 900 is configured to generate messages to investigators in response to receiving new data or documents or changes to existing data or documents related to fraud ring investigations. In particular, as shown in FIG. 11, the module 900 begins at Step 920 by receiving an indication from the documentation module, such as the documentation module 300 discussed above in relation to FIG. 5, that new data or documents have been received by the documentation module or that existing data or documents have been changed via the documentation module. In response to receiving an indication that new data or documents have been received or that existing data or documents have been changed, the module 900 generates a message indicating whether new data or documents have been received or existing data or documents have been changed, as shown in Step 922, and communicates the message to one or more users associated with the fraud ring investigation for which new data and/or documents have been received or for which existing data and/or documents have been changed, as shown in Step 924. In a particular embodiment (not shown), the module 900 also sends the message to managers associated with the assigned investigator and an administrator(s) of the system 100. According to certain embodiments, the message may be an email, a MMS, or a message displayable on a screen of the investigator computing device 140a, 140b, 140c. In a particular embodiment, the message further includes a hyperlink associated with the fraud ring investigation that is selectable to view the data entered.

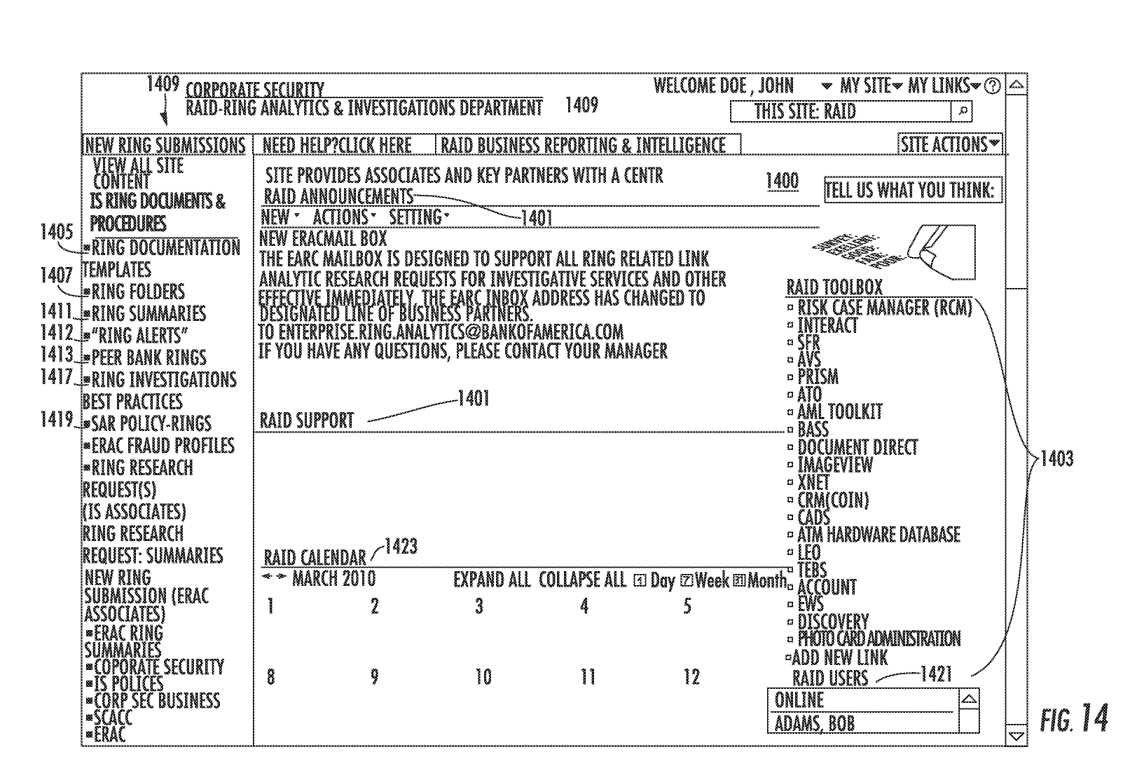

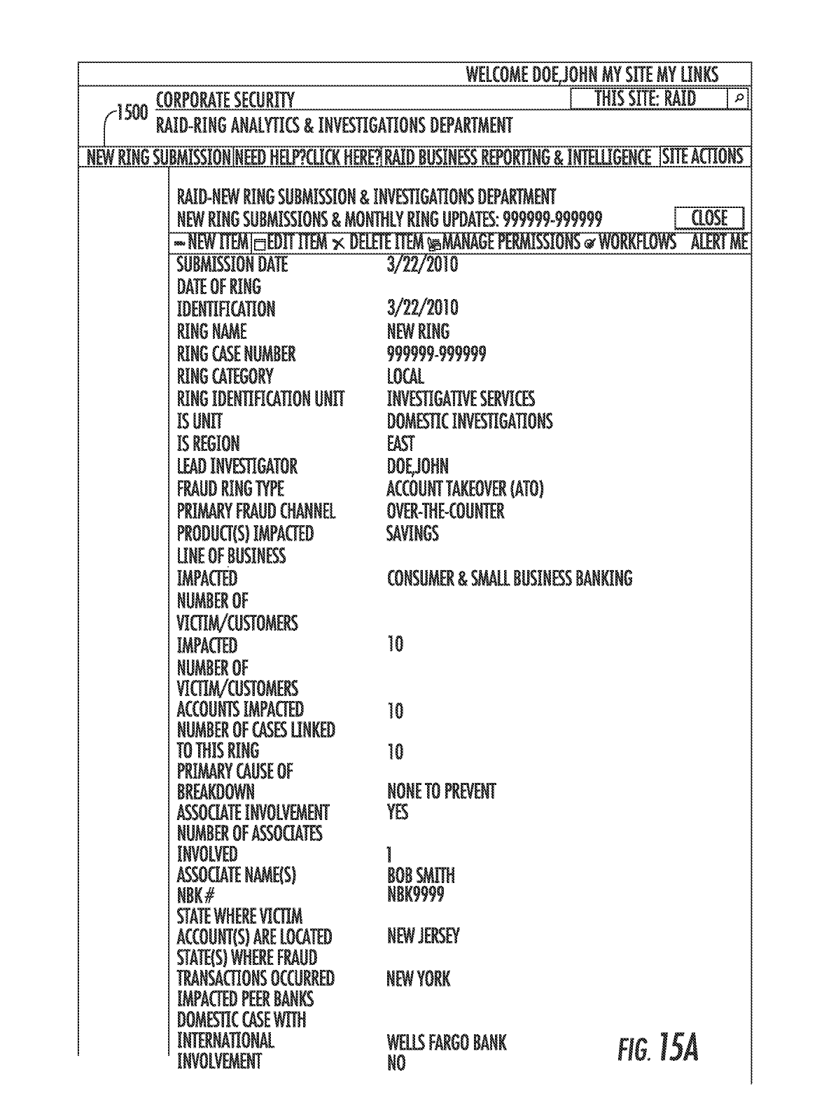

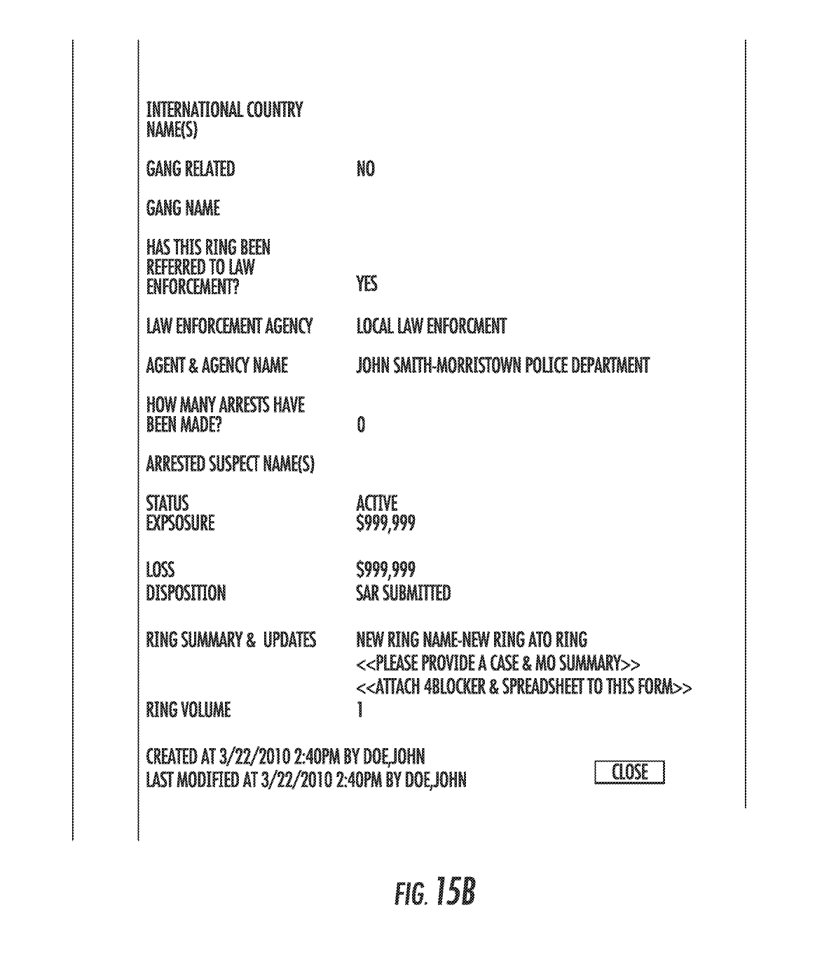

Furthermore, according to various embodiments (not shown), the communication module 900 is further configured to receive announcements that may be of interest to all investigators that use the fraud ring investigation management system and communicate the received announcements to each investigator computing device 140a, 140b, 140c for display thereon upon accessing the system 100. According to various embodiments, these announcements may be displayed on the home page for the fraud ring investigation management system, such as shown in FIG. 14.

Tracking Module

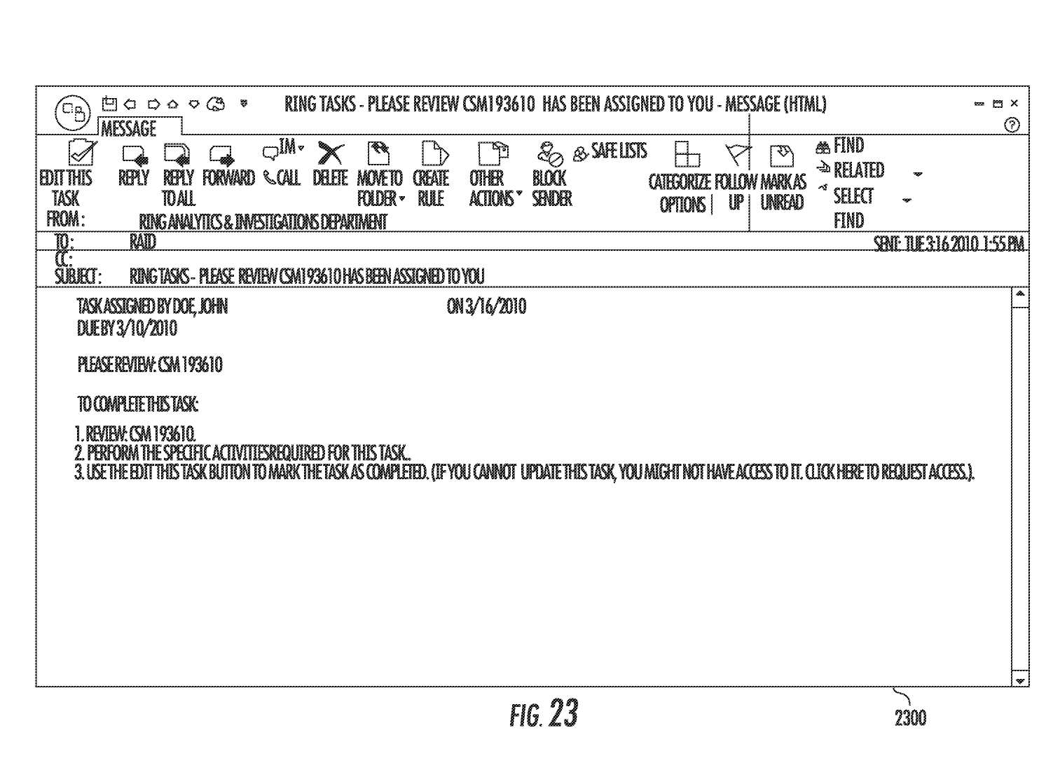

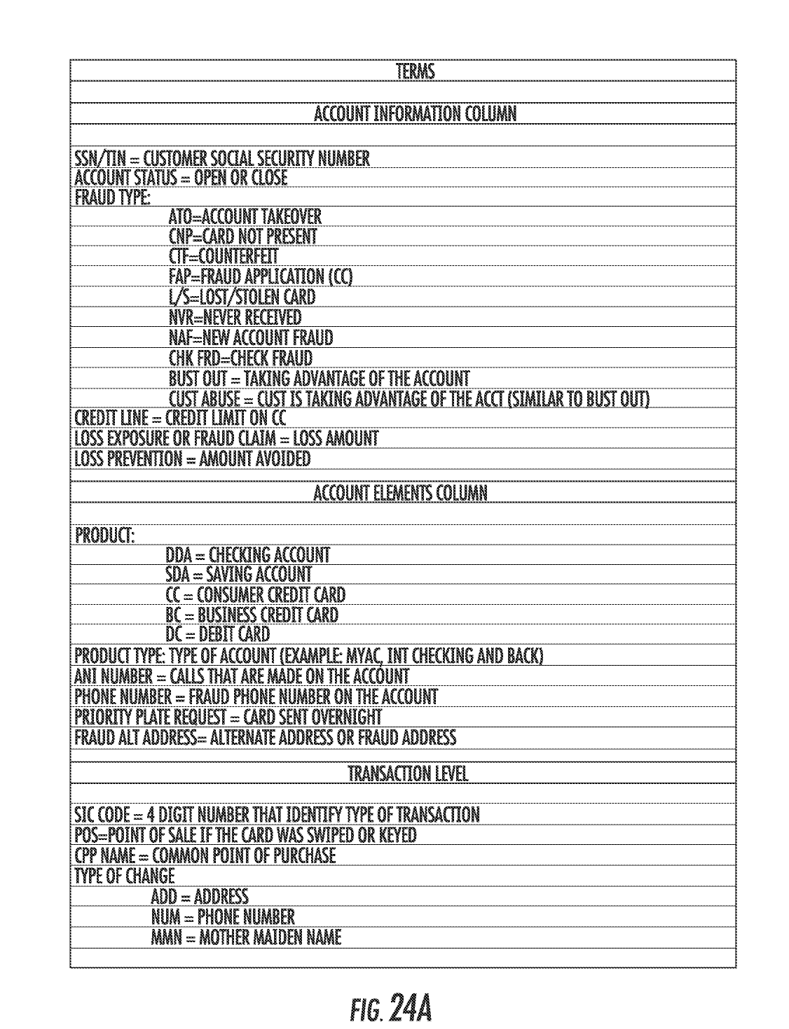

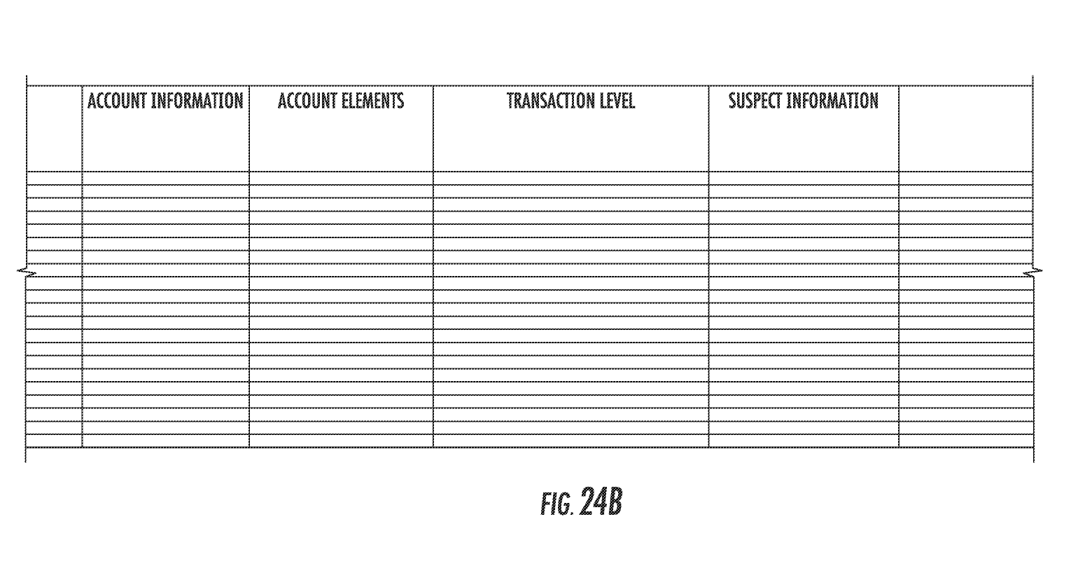

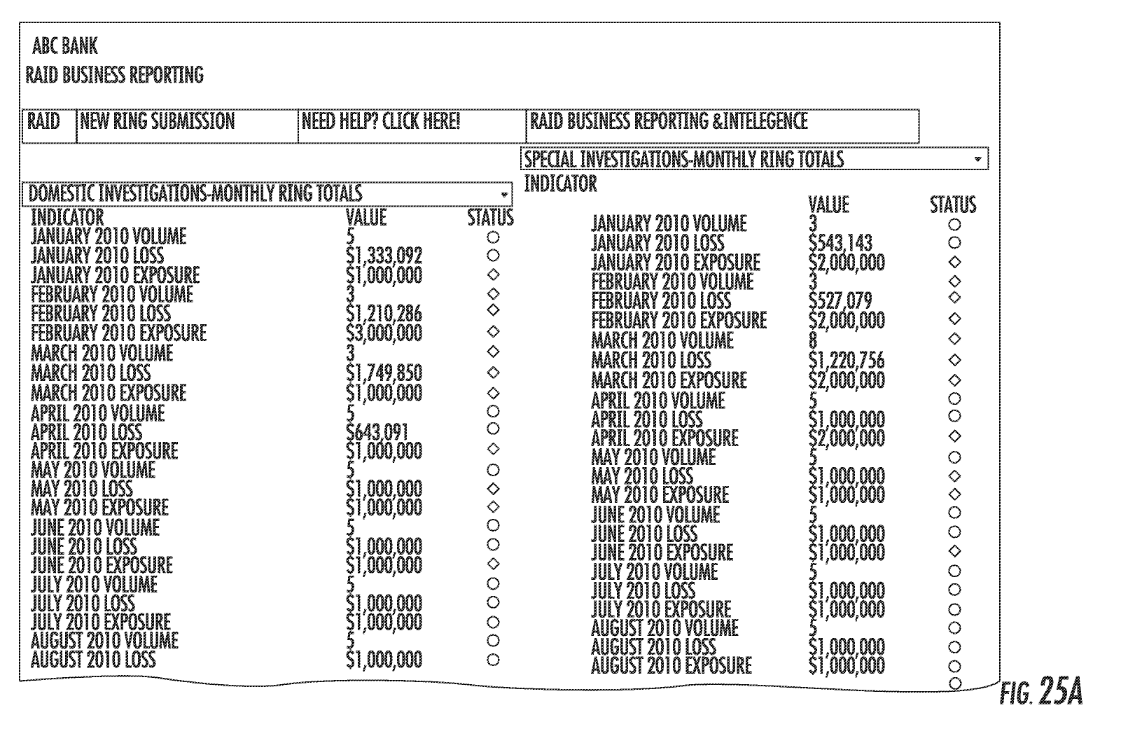

FIG. 12 illustrates a tracking module 1100 according to various embodiments of the invention. The tracking module 1100 begins at Step 1102 by receiving a request from a first investigator's investigator computing device 140a, 140b, 140c to assign a task related to a fraud ring investigation to a second investigator. In response, the tracking module 1100 generates a message for the second investigator indicating that the task has been assigned to the second investigator, as shown in Step 1104. The message is then communicated to the second investigator's investigator computing device 140a, 140b, 140c, as shown in Step 1106. In one embodiment, the message further includes a hyperlink to another webpage or document that describes the assigned task. For example, FIG. 23 illustrates a screen shot of an email message 2300 that includes a link (“CSM 193610”) to the task assigned to the recipient of the email. In an alternative embodiment, the generated request may include a description of the assigned task that has been assigned. According to various embodiments, the assigned task may be, for example, a request to manage the investigation of the fraud ring or a request to research one or more discrete aspects of the fraud ring.

In a further embodiment, the module 1100 receives an indication from the second investigator's investigator computing device 140a, 140b, 140c when the task has been completed, as shown in Step 1108, and, in response, communicates a message to the first investigator's investigator computing device 140a, 140b, 140c indicating that the task has been completed in Step 1110.

The tracking module 1100 is further configured to generate a calendar for each investigator listing deadlines (e.g., internal and external deadlines) related to the fraud ring investigations assigned to respective investigator, as shown in Step 1112. In Step 1114, the module 1100 communicates each calendar to the respective investigator's investigator computing device 140a, 140b, 140c. In various embodiments (not shown), the tracking module 1100 is further configured to generate messages (e.g., email, text message, instant message) reminding investigators of their upcoming deadlines and communicating the messages to the respective investigator computing device 140a, 140b, 140c.

Reporting Module

To assist investigators, managers, and/or administrators with managing and reporting data related to one or more fraud ring investigations, the system 100 includes a reporting module that allows the user to create report templates and generate summary reports using the report templates. FIG. 13 illustrates a reporting module 1200 according to various embodiments of the invention. To create a report template, the reporting module 1200 receives preselected types of fraud ring data for including in each of one or more report templates at Step 1202. The preselected types of fraud ring data for including in each report template may be provided by various users of the system 100, including investigators, administrators, and managers. For example, in various embodiments, the reporting module 1200 may store the following report templates: (1) a report listing totals for key performance indicators (e.g., loss/exposure over a certain period of time, number of active fraud ring investigations, number of affected customers and/or accounts) associated with one or more fraud ring investigations (see e.g., the report shown in FIG. 24), (2) a report for each line of business partner that lists the fraud rings affecting the respective line of business partner and the amount of loss/exposure associated with each fraud ring, (3) a report providing summaries of loss/exposure resulting from one or more fraud rings over a certain time period (e.g., yearly, quarterly, monthly, or weekly), (3) a report providing progress summaries for one or more fraud ring investigations over a certain time period and/or for a particular investigator or group of investigators, (4) a report providing a summary of fraud rings utilizing a particular primary fraud channel, and/or (5) a report providing a summary of fraud rings affecting a particular geographical area (e.g., a group of states, counties, cities, zip codes, etc.). Then, in Step 1204, the reporting module 1200 stores each received report template on the database server 120.

To generate reports using the stored report templates, the module 1200 generates a listing of the one or more report templates that are available to the user in Step 1206, and in Step 1208, communicates this listing to the user's computing device 140a, 140b, 140c for displaying thereon. The user then selects one of the report templates. In certain embodiments, if the selected report requires specific criteria to create the report, the user specifies the criteria to be used in generating the selected report. For example, the user may select the report template providing a summary of fraud rings utilizing a particular primary fraud channel and specify “online banking” as the primary fraud channel type to be used in identifying the fraud rings to be included in the report. In Step 1210, the user's selection of the type of report template and the criteria to be used in generating the selected report, if applicable for the selected type of report, are received by the module 1200, and in response, as shown in Step 1212, the module 1200 retrieves fraud ring investigation data associated with the report template and, if applicable, matching the specific criteria. According to various embodiments, the reporting module 1200 then calls the access control module to ensure that the user requesting the report has permission to access the data to be included in the report. If permission is granted, the reporting module 1200 continues to Step 1214.

In Step 1214, the module 1200 generates the report with the retrieved data as specified by the report template, and in Step 1216, communicates the report to the requesting user's computing device 140a, 140b, 140c. For example, the module 1200, according to the example set forth above, retrieves data related to all fraud ring investigations for which online banking is the primary fraud channel and generates a report that includes the data specified in the selected report template. According to various embodiments (not shown), the reporting module 1200 is further configured to export the data included in the report to another application running on the user's computing device 140a, 140b, 140c, such as, for example, MS Excel or a similar application.

In certain embodiments, the module 1200 updates generated reports in substantially real time in response to the system 100 receiving new or updated fraud ring summary profile data related to each fraud ring investigation included in the report. For example, in a report listing key performance indicators, the report may include the total amount of loss resulting from all active fraud ring investigations. When the user changes the amount of loss for one particular active fraud ring investigation, the total amount of loss displayed in the report is updated in substantially real-time.

In addition, according to certain embodiments (not shown), the reporting module 1200 allows the user to select certain text or fields in the generated report to view additional details related to the text or fields. For example, in a report listing key performance indicators, the investigator may select one of the indicators to view a listing of the one or more fraud ring summary profiles that include data used to determine the value associated with the selected indicator. For example, according to the embodiment shown in FIG. 24, the key performance indicator report indicates that the total loss in January 2010 for active domestic fraud rings is $1,333,092, and when the user selects the “January 2010 Loss” text in the report, the reporting module 1200 retrieves the fraud ring summary profile data for the active domestic fraud ring investigations for which a loss was reported for January 2010, and the retrieved fraud ring summary profile data is communicated to the investigator's investigator computing device 140a, 140b, 140c for display thereon.

Exemplary Operation of System

According to various embodiments, the investigator accesses the system via the Internet or the financial institution's Intranet by entering an appropriate web address into a web browser. The identity of the investigator accessing the system 100 is captured, and the system 100 verifies whether the investigator has access to the system 100. In certain embodiments, the system 100 captures the identity of the investigator accessing the system 100 from the operating system of the investigator's investigator computing device 140a, 140b, 140c. In an alternative embodiment, the system 100 allows the investigator to log into the system 100 upon accessing the website of the system 100.

Once access to the website is granted, a home page, such as the partial view of the exemplary home page 1400 shown in FIG. 14, is displayed according to various embodiments. The home page 1400 includes, for example, announcements 1401 related to investigative services, links 1403 to investigative tools that may be useful to the investigator using the system 100, a link 1405 to fraud ring documentation templates, a link 1407 to fraud ring folders associated with existing fraud ring investigations, a link 1409 to the new ring submission form, a link 1411 to report templates, a link 1413 to fraud rings identifier by line of business partners, a link 1415 to fraud ring alerts, a link 1417 to view guidelines describing best practices in investigating fraud rings, a link 1419 describing the financial institution's policy regarding Suspicious Activity Reports (SARs), a listing 1421 of investigators currently using the system, and a calendar 1423 listing one or more deadlines associated with fraud ring investigations assigned to or of interest to the user of the system.

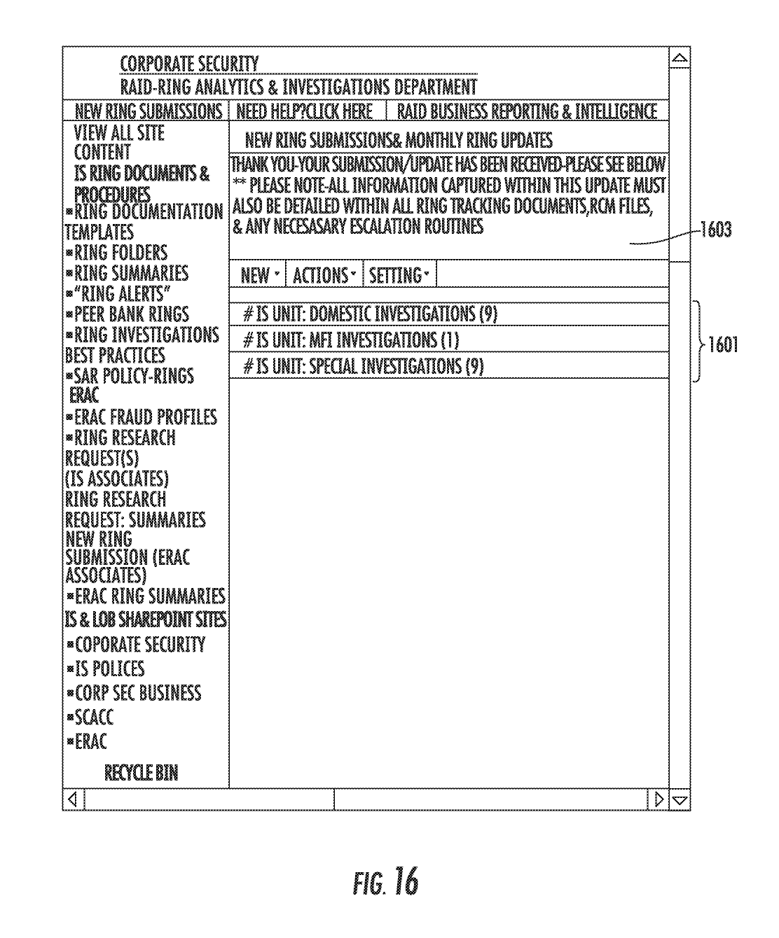

Upon selection of the link 1409 to the new ring submission form, the new ring submission form, such as the new ring submission form 1500 shown in FIG. 15, is communicated to the investigator's investigator computing device 140a, 140b, 140c and displayed thereon. In particular, according to the embodiment shown in FIG. 15, the new ring submission form 1500 receives fraud ring summary profile data and displays previously entered data. According to the embodiment shown in FIG. 15, the form 1500 includes the following fields for receiving data from the investigator's investigator computing device 140a, 140b, 140c and/or displaying previously entered data to the investigator: a submission date for the current submission, a date on which the fraud ring was identified, a ring name, a ring case number, the unit of the financial institution that identified the fraud ring, the investigative services unit and region conducting the investigation (e.g., domestic investigations, east division; international investigations), the lead investigator assigned to the fraud ring investigation, the type of fraud ring, the primary fraud channel of the fraud ring, the financial products impacted, the line of business impacted, the number of victims impacted, the number of accounts impacted, the number of cases linked to the fraud ring, the primary cause of breakdown, whether there is any associate involvement, the number of associates involved, the names of associates involved, an employee identifier (e.g., an employee number, name, or alpha-numeric combination) identifying an employee of the financial institution involved with the fraud ring (if any), the state where victims are located, the state(s) where fraudulent transactions occurred, any impacted peer banks, whether this is a domestic fraud ring case with international involvement, a listing of any international countries involved, whether the fraud ring is gang related, whether the fraud ring has been referred to law enforcement, the law enforcement agency involved, the law enforcement agent and agency name, the number of arrests made, the arrested suspect names, the status of the fraud ring investigation (e.g., active, closed), the exposure to the financial institution, the loss to the financial institution, the disposition of the fraud ring investigation (e.g., whether a SAR has been submitted, whether accounts have been closed or cards have been blocked, whether a case is in progress, or other mitigating or investigative steps performed during in investigation), a text box to include a new fraud ring name, if necessary, and a brief description of the fraud ring, and a ring volume number to indicate the number of rings associated with the ring profile summary (e.g., the ring volume is typically one, but when, for example, two investigators enter ring summary profile data related to the same ring, the number is two). In addition, according to the embodiment shown in FIG. 15, the form includes a data/time stamp indicating when the ring profile summary was first created and when the ring profile summary was last modified. After receiving data into the new ring submission form, the system 100 generates and communicates a message, such as message 1603 shown in FIG. 16, to the investigator computing device 140a, 140b, 140c indicating that the data submission has been received. The system 100 may also generate an email notification to the investigator submitting the data and to the administrator of the system 100, according to various embodiments. An exemplary email notification to the administrator of the system 100 according to one embodiment is shown in FIG. 17.

FIG. 16 illustrates a partial view of a fraud ring summary list, which provides an expandable listing 1601 of all of the fraud rings grouped by the investigative services unit to which the fraud ring investigation is assigned (e.g., domestic investigations, mortgage fraud investigations (MFI), and special investigations). Each group may be expanded to provide a listing of all of the fraud ring investigations belonging to the respective group by clicking on the group description, for example.

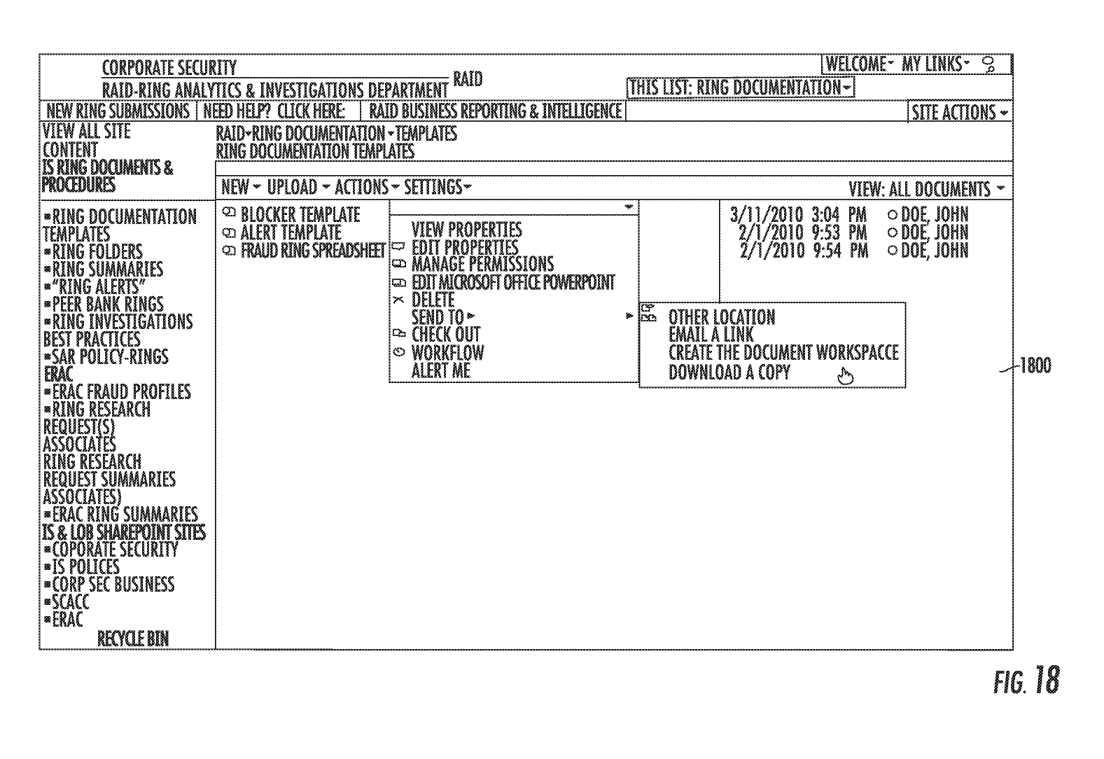

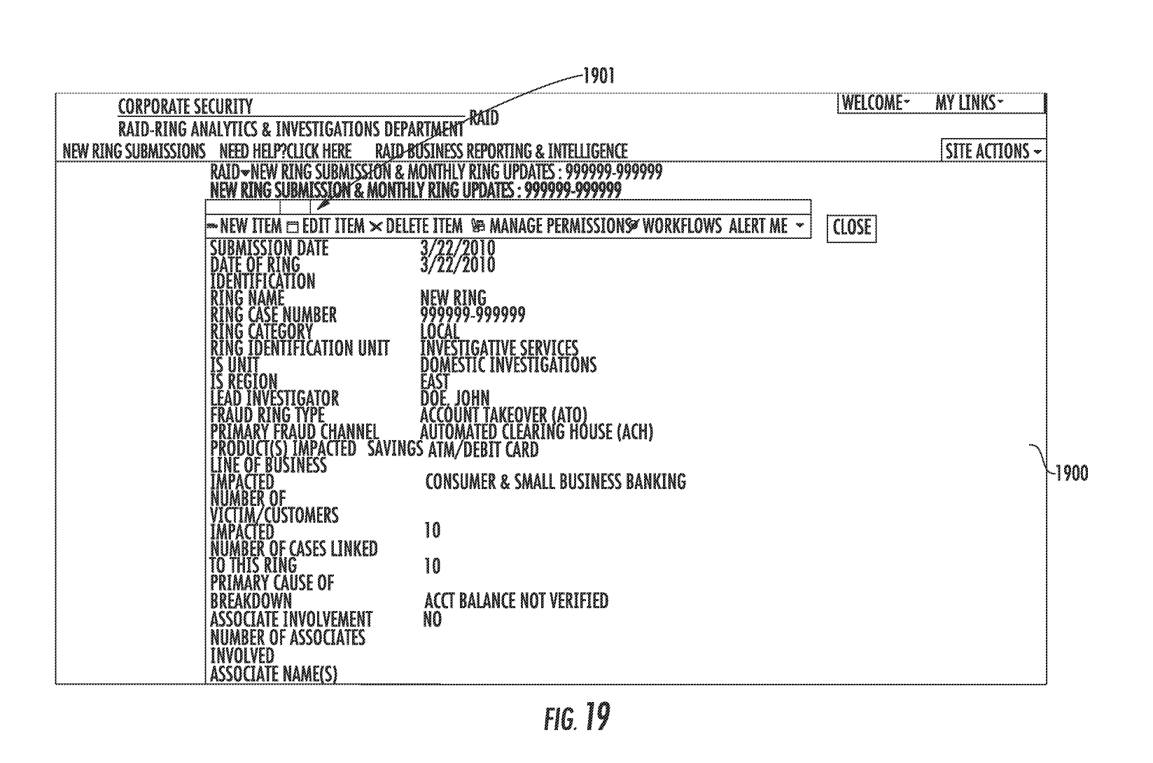

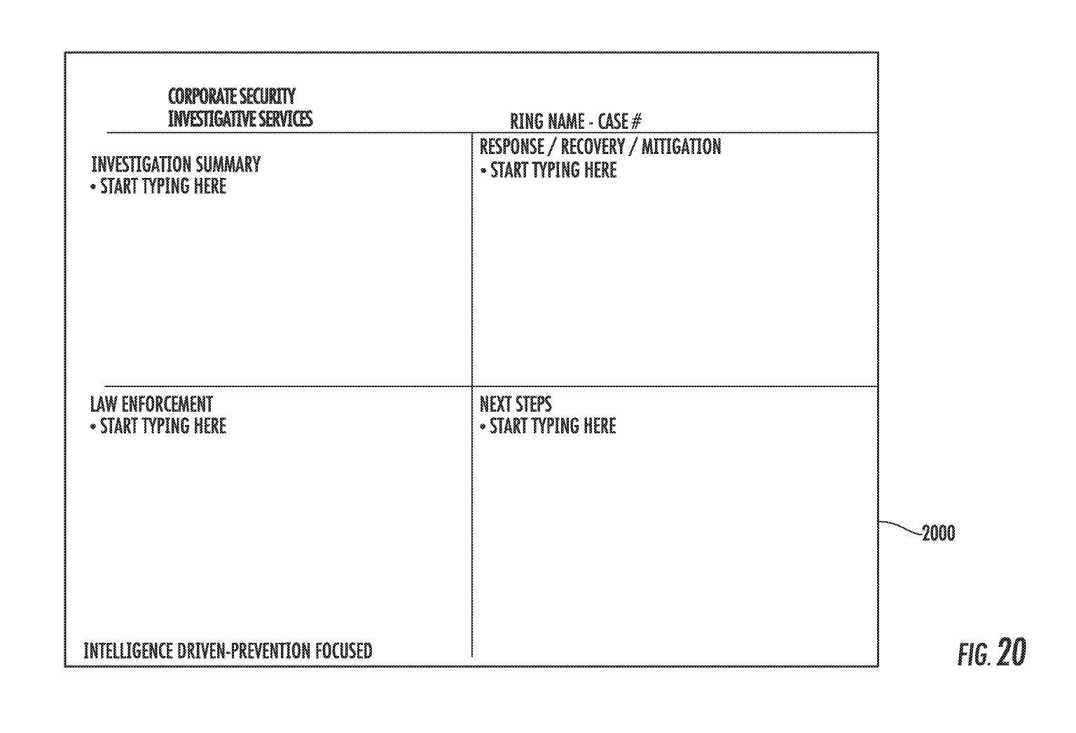

As noted above, the investigator may select a ring documentation template link to access document templates used to create documents supporting the fraud ring investigation. For example, according to various embodiments, after the investigator selects the ring documentation template link 1405 shown in FIG. 14, the system 100 displays a ring documentation template page, such as the ring documentation template page 1800 shown in FIG. 18. The ring documentation template page 1800 lists various documentation templates available for selection by the investigator, such as, for example, a 4 Blocker template (e.g., the 4 Blocker template 2000 shown in FIG. 20), an alert template (e.g., the alert template 2100 shown in FIG. 21), and a fraud ring spreadsheet template (e.g., the fraud ring spreadsheet template shown in FIGS. 24A and 24B). Upon selection one of these templates by the investigator, the system 100 displays a list of options related to the selected template, such as downloading a copy of the template to the investigator's investigator computing device 140a, 140b, 140c or emailing a copy of the template to another user of the system 100.

After data related to the fraud ring investigation has been submitted to the system 100, the investigator may create one or more folders related to the fraud ring investigation or upload one or more documents related to the fraud ring investigation by accessing a fraud ring folders page, such as the fraud ring folders page 1700 shown in FIG. 17, according to various embodiments. In particular, according to one embodiment, the investigator selects the “new” link 1701 to create a new folder or a new document, and the investigator selects the “upload” link 1703 to upload one or more documents to the system 100.

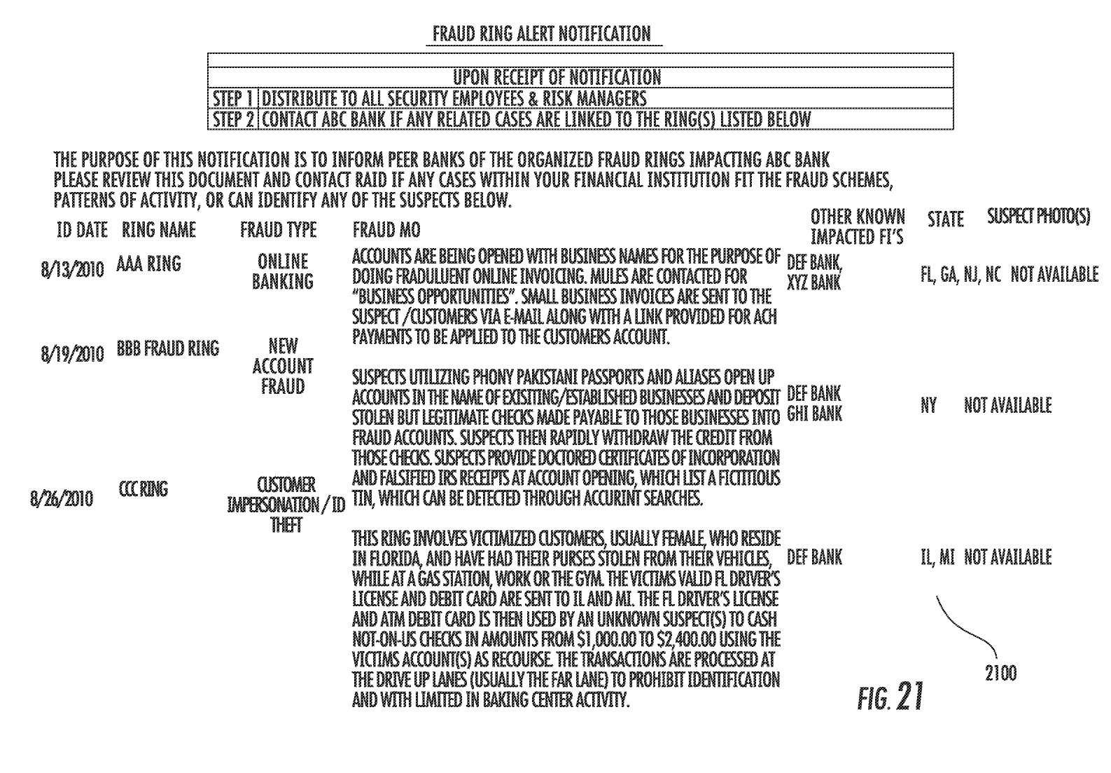

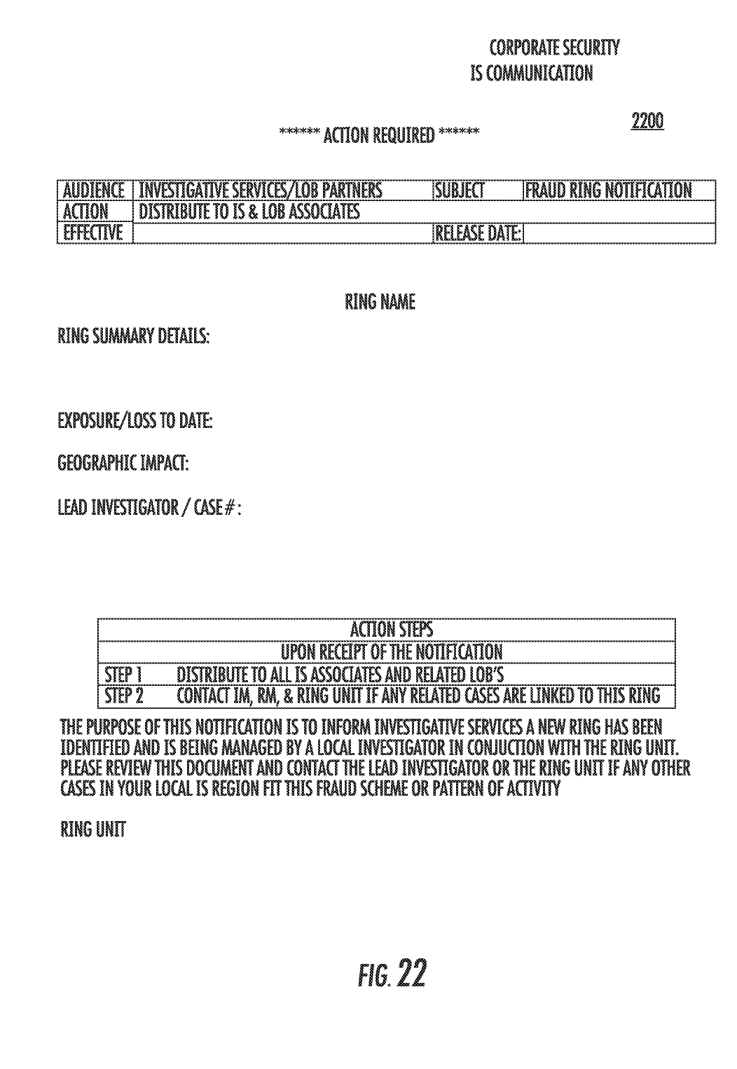

In addition, the investigator or other investigators may view and edit data related to existing fraud ring investigations by selecting the fraud ring investigation from the fraud ring summary list, such as described above in relation to FIG. 16. At least a portion of the previously entered data is displayed on a cover page related to the fraud ring investigation, such as the cover page 1900 shown in FIG. 19. From this cover page, the investigator or another investigator may edit the data or add additional data by selecting the “edit” button 1901 displayed on the cover page 1900 and entering the new data into the appropriate field.

In various embodiments, the investigator or other investigators may search for fraud ring investigations associated with data or documents having certain search terms, such as described above in relation to FIG. 8. For example, in a particular embodiment, the investigator enters the search terms into a “Search” text box on the home page of the website, and after selecting the “Search” button, the results of the search are displayed for the investigator.

When a new fraud ring has been identified and is being managed by a local investigator in conjunction with the assigned fraud ring unit, the investigator or other user of the system 100 may create an alert for sending to other investigators within the financial institution and to line of business partners that may have information related to the identified fraud ring. For example, the alert document 2200 shown in FIG. 22 includes a field for providing summary details regarding the fraud ring, exposure/loss information to date, geographic impact, and the contact name of the lead investigator and number associated with the fraud ring investigation.

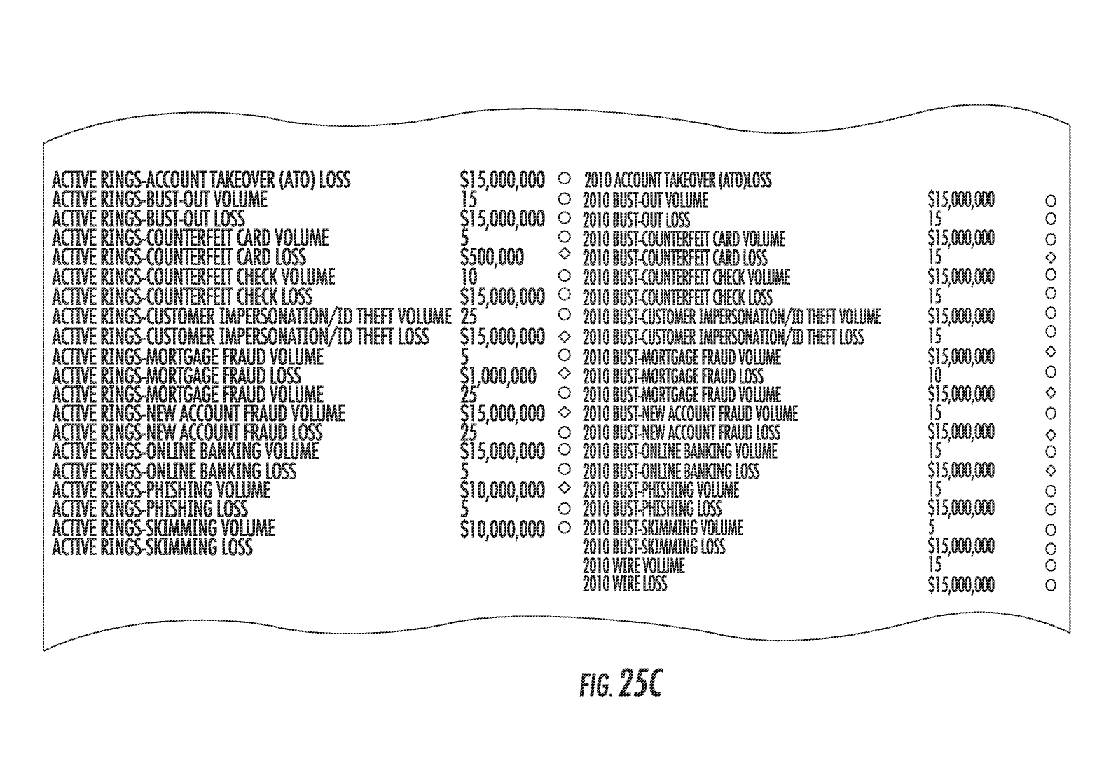

In addition, as discussed above in relation to FIG. 13, the reporting module 1200 receives a selection of a report to be generated, retrieves the data to be included in the report, and generates and communicates the report for display to the user. FIGS. 25A-25C illustrate partial views of a key performance indicator report according to one embodiment of the invention. The key performance indicator report lists summary details of various key performance indicators preselected to be included in the report, such as, for example, monthly totals for fraud ring volume, loss, and exposure for all domestic fraud ring investigations and special fraud ring investigations, total number of active fraud ring investigations (see e.g., “Active Ring Volume” indicator), total amount of loss from active fraud ring investigations (see e.g., “Active Ring Loss” indicator), and total number of customers impacted by active fraud ring investigations (see e.g., “Active Ring Victim/Customer Impact”). As an example, the summary detail for each key performance indicator shown in FIGS. 25A-25C is the value associated with the key performance indicator, according to the embodiment shown in FIGS. 25A-25C.

### CONCLUSION

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein. Although specific terms are employed herein, they are used in a generic and descriptive sense and not necessarily for the purposes of limitation.

1. A fraud ring investigation management system comprising:
a fraud ring database configured to store a set of electronic data associated with each of one or more fraud ring investigations, each set of electronic data comprising one or more fraud elements and a fraud ring identifier unique to each of the one or more fraud ring investigations; and
a fraud ring investigation application configured to manage a network collection of the set of electronic data associated with each of the one or more fraud ring investigations.

2. The fraud ring investigation management system of claim 1 wherein the one or more fraud elements comprises one or more of the following: a geographic location, an electronic mail address, a physical address, or an internet protocol address.

3. The fraud ring investigation management system of claim 2 wherein the one or more fraud elements further comprises one or more of a suspect name, primary fraud channel, or a financial product.

4. The fraud ring investigation management system of claim 1 wherein the one or more fraud elements comprises one or more of a suspect name, primary fraud channel, or a financial product.

5. The fraud ring investigation management system of claim 1 wherein:
the set of electronic data associated with each of the one or more fraud ring investigations comprises a first set of electronic data associated with a first fraud ring investigation and a second set of electronic data associated with a second fraud ring investigation, and
the fraud ring investigation application is further configured to receive electronically via a communications network the first set of electronic data from a first investigator computing device and the second set of electronic data from a second investigator computing device, the first investigator computing device and the second investigator computing device being disposed remotely from each other.

6. The fraud ring investigation management system of claim 5 wherein the fraud ring investigation application is further configured to:
generate, via a computer processor, a fillable form;
electronically communicate the fillable form via the communications network to the first investigator computing device and the second investigator computing device;
receive the first set of electronic data into the fillable form from the first investigator computing device;
receive the second set of electronic data into the fillable form from the second investigator computing device; and
communicate the first set of electronic data and the second set of electronic data to the fraud ring database, wherein the first set of electronic data comprises a first fraud ring identifier and the second set of electronic data comprises a second fraud ring identifier.

7. The fraud ring investigation management system of claim 5 wherein the fraud ring investigation application is further configured to:
receive a first document related to the first fraud ring investigation;
link, via a computer processor, the first document with the first fraud ring identifier; and
communicate the first document to the fraud ring database for storage with the first set of electronic data.

8. The fraud ring investigation management system of claim 7 wherein the fraud ring investigation application is further configured to:
receive a second document related to the first fraud ring investigation;
link, via the computer processor, the second document with the first fraud ring identifier; and
communicate the second document to the fraud ring database for storage with the first set of electronic data.

9. The fraud ring investigation management system of claim 8 wherein the fraud ring investigation application is further configured to:
receive a third document related to a second fraud ring investigation;
link, via the computer processor, the third document with the second fraud ring identifier; and
communicate the third document to the fraud ring database for storage with the second set of electronic data.

10. The fraud ring investigation management system of claim 7 wherein the fraud ring investigation application is further configured to:
receive a third document related to a second fraud ring investigation;
link, via the computer processor, the third document with the second fraud ring identifier; and
communicate the third document to the fraud ring database for storage with the second set of electronic data.

11. The fraud ring investigation management system of claim 1 wherein the fraud ring investigation application is further configured to manage the network collection of one or more documents associated with each of the one or more fraud ring investigations.

12. The fraud ring investigation management system of claim 1 further comprising a fraud ring investigator profile database configured to store an investigator profile associated with each of one or more investigators, each investigator profile comprising an investigator identifier unique to each investigator and access permissions.

13. The fraud ring investigation management system of claim 12 wherein:
the set of electronic data associated with each of the one or more fraud ring investigations comprises a first set of electronic data associated with a first fraud ring investigation, and
the fraud ring investigation application is further configured to:
receive electronically via a communications network the first set of electronic data from a computing device being used by a first investigator, wherein the first set of electronic data comprises a first investigator identifier identifying the first investigator;
in response to receiving the first set of electronic data, retrieve a first investigator profile associated with the first investigator identifier;
compare, via a computer processor, access permissions of the first investigator profile with an action requested by the first investigator;
in response to the action requested by the first investigator being allowed per the access permissions of the first investigator profile, permit the action requested; and
in response to the action requested by the first investigator not being allowed per the access permissions of the first investigator profile, generate, via the computer processor, a notification indicating that the action is not allowed and communicate the notification to the computing device.

14. The fraud ring investigation management system of claim 13 wherein the action requested comprises one or more of: saving the first set of electronic data or editing the first set of electronic data.

15. The fraud ring investigation management system of claim 1 wherein the fraud ring investigation application is further configured to:
receive one or more search terms from an investigator computing device,
in response to receiving the one or more search terms, identify, via a computer processor, a first set of electronic data associated with a first fraud ring investigation stored in the fraud ring database that includes the one or more search terms; and
in response to identifying the first set of electronic data, generating, via the computer processor, a first hyperlink displayable by the investigator computing device, the first hyperlink being selectable to view at least a portion of the first set of electronic data.

16. The fraud ring investigation management system of claim 15 wherein the fraud ring investigation application is further configured to:
in response to receiving the one or more search terms, identify, via the computer processor, a second set of set of electronic data associated with a second fraud ring investigation stored in the fraud ring database that includes the one or more search terms; and
in response to identifying the second set of electronic data, generating, via the computer processor, a second hyperlink displayable by the investigator computing device, the second hyperlink being selectable to view at least a portion of the second set of electronic data.

17. The fraud ring investigation management system of claim 16 wherein the fraud ring investigation application is further configured to:
receive a selection of the first hyperlink or the second hyperlink from the investigator computing device;
in response to receiving the selection of the first hyperlink, communicate at least a portion of the first set of electronic data to the investigator computing device; and
in response to receiving the selection of the second hyperlink, communicate at least a portion of the second set of electronic data to the investigator computing device.

18. The fraud ring investigation management system of claim 17 wherein the first hyperlink comprises hypertext comprising the first fraud ring identifier and the second hyperlink comprises hypertext comprising the second fraud ring identifier.

19. The fraud ring investigation management system of claim 17 wherein:
one or more first documents associated with the first fraud ring investigation are linked to the first fraud ring identifier in the fraud ring database and one or more second documents associated with the second fraud ring investigation are linked to the second fraud ring identifier in the fraud ring database, and
the fraud ring investigation application is further configured to:
in response to receiving a selection of the first hyperlink, generate and communicate first document hyperlinks associated with each of the one or more first documents to the investigator computing device, the first document hyperlinks being displayable by the investigator computing device, and
in response to receiving a selection of the second hyperlink, generate and communicate second document hyperlinks associated with each of the one or more second documents to the investigator computing device, the second document hyperlinks being displayable by the investigator computing device.

20. A computer-implemented method of documenting a fraud ring investigation, said method comprising:
generating, via a computer processor, a fillable form displayable to a user via a computing device, the fillable form comprising one or more fields for receiving data related to a fraud ring investigation;
receiving a first set of data into the fillable form via the computing device, the first set of data being related to a first fraud ring investigation and the first set of data comprising (1) a first fraud ring identifier and (2) one or more fraud elements related to the first fraud ring investigation; and
in response to receiving the first set of data, storing the first set of data in a memory.

21. The computer-implemented method of claim 20 wherein the computing device is a first computing device and the computer processor is in a second computing device, the first and second computing devices being in communication with each other via a communication network and disposed remotely from each other.

22. The computer-implemented method of claim 21 wherein the memory is in the second computing device.

23. The computer-implemented method of claim 21 wherein the memory is in a third computing device in communication with the first and second computing devices via the communication network and disposed remotely from at least the first computing device.

24. The computer-implemented method of claim 20 further comprising:
in response to storing the first set of data, generating, via a computer processor, a first electronic message confirming that the first set of data has been received; and
communicating the first electronic message to the computing device, the first electronic message being displayable by the computing device.

25. The computer-implemented method of claim 24 wherein the first electronic message comprises a first hyperlink, and the method further comprising:
receiving a selection of the first hyperlink from the computing device via the communication network;
in response to receiving the selection of the first hyperlink, retrieving at least a portion of the first set of data stored in the memory; and
communicating the at least a portion of the first set of data to the computing device, the at least a portion of the first set of data being displayable by the computing device.

26. The computer-implemented method of claim 20 further comprising:
receiving one or more electronic documents related to the first fraud ring;
linking, via the computer processor, the one or more electronic documents related to the first fraud ring with the first fraud ring identifier; and
storing the one or more electronic documents related to the first fraud ring in the memory.

27. The computer-implemented method of claim 20 further comprising:
receiving a second set of data into the fillable form via the computing device, the second set of data being related to a second fraud ring investigation and the second set of data comprising (1) a second fraud ring identifier and (2) one or more fraud elements related to the second fraud ring investigation; and
in response to receiving the second set of data, storing the second set of data in the memory.

28. The computer-implemented method of claim 27 further comprising:
in response to storing the second set of data, generating, via the computer processor, a second electronic message confirming that the second set of data has been received, the second electronic message comprising a second hyperlink, the second hyperlink being selectable by the user of the computing device to view at least a portion of the second set of data.

29. The computer-implemented method of claim 20 wherein the computing device is a first computing device and the method further comprises:
receiving a second set of data into the fillable form via a second computing device, the second set of data being related to a second fraud ring investigation and the second set of data comprising (1) a second fraud ring identifier and (2) one or more fraud elements related to the second fraud ring investigation; and
in response to receiving the second set of data, storing the second set of data in the memory.

30. The computer-implemented method of claim 29 further comprising:
in response to storing the second set of data, generating, via the computer processor, a second electronic message confirming that the second set of data has been received, the second electronic message comprising a second hyperlink, the second hyperlink being selectable by the user of the second computing device to view at least a portion of the second set of data.

31. The computer-implemented method of claim 29 further comprising:
receiving one or more documents related to the second fraud ring;
linking, via the computer processor, the one or more documents related to the second fraud ring with the second fraud ring identifier; and
storing the one or more documents related to the second fraud ring in the memory.

32. The computer-implemented method of claim 29 further comprising:
generating, via the computer processor, a first hyperlink comprising hypertext comprising the first fraud ring identifier and a second hyperlink comprising hypertext comprising the second fraud ring identifier, the first and second hyperlinks being displayable on the first computing device and the second computing device;
in response to receiving a selection of the first hyperlink from the first computing device, retrieving at least a portion of the first set of data for communicating to the first computing device;
in response to receiving a selection of the second hyperlink from the first computing device, retrieving at least a portion of the second set of data for communicating to the first computing device;
in response to receiving a selection of the first hyperlink from the second computing device, retrieving at least a portion of the first set of data for communicating to the second computing device; and
in response to receiving a selection of the second hyperlink from the second computing device, retrieving at least a portion of the second set of data for communicating to the second computing device.

33. The computer-implemented method of claim 32 further comprising:
in response to receiving a selection of the second hyperlink from the first computing device, retrieving access permissions associated with an investigator using the first computing device, the access permissions indicating whether the investigator may view at least a portion of the second set of data;
in response to the retrieved access permissions indicating that the investigator may view at least a portion of the second set of data, communicating the at least a portion of the second set of data to the first computing device, the second set of data being displayable by the first computing device; and
in response to the retrieved access permissions indicating that the investigator may not view at least a portion of the second set of data, generating, via the computer processor, an electronic message indicating that access is not granted and communicating the electronic message to the first computing device, the electronic message being displayable by the first computing device.

34. The computer-implemented method of claim 32 further comprising:
in response to receiving a selection of the first hyperlink from the second computing device, retrieving access permissions associated with an investigator using the second computing device, the access permissions indicating whether the investigator may view at least a portion of the first set of data;
in response to the retrieved access permissions indicating that the investigator may view at least a portion of the first set of data, communicating the at least a portion of the first set of data to the second computing device, the at least a portion of the first set of data being displayable by the second computing device; and
in response to the retrieved access permissions indicating that the investigator may not view at least a portion of the first set of data, generating, via the computer processor, an electronic message indicating that access is not granted and communicating the electronic message to the second computing device, the electronic message being displayable by the second computing device.

35. The computer-implemented method of claim 29 further comprising:
generating, via the computer processor, a calendar, wherein the calendar indicates one or more deadlines related to the first fraud ring investigation.

36. The computer-implemented method of claim 35 wherein the calendar further indicates one or more deadlines related to the second fraud ring investigation.

37. The computer-implemented method of claim 29 further comprising:
generating, via the computer processor, a calendar to be to a third user via a third computing device, wherein the calendar indicates one or more deadlines related to the first fraud ring investigation and the second fraud ring investigation.

38. The computer-implemented method of claim 20 further comprising:
after storing the first set of data, receiving a third set of data into the fillable form, the third set of data being related to the first fraud ring investigation;
in response to receiving the third set of data, linking, via the computer processor, a subsequent version indicator with the third set of data, the subsequent version indicator indicating that the third set of data was received after the first set of data; and
storing the third set of data and the subsequent version indicator in the memory.

39. The computer-implemented method of claim 20 further comprising:
after storing the first set of data, receiving a third set of data into the fillable form, the third set of data being related to the first fraud ring investigation;
in response to receiving the third set of data, linking, via the computer processor, a subsequent version indicator with portions of the third set of data that are different than the first set of data, the subsequent version indicator indicating that the third set of data was received after the first set of data; and
storing the third set of data and the subsequent version indicator in the memory.

40. The computer-implemented method of claim 39 wherein the computing device is a first computing device and the third set of data is received from a second computing device, the first and second computing devices being disposed remotely from each other and in communication with each other via a communications network.

41. The computer-implemented method of claim 20 further comprising:
generating, via the computer processor, a first hyperlink associated with a first investigative tool and a second hyperlink associated with a second investigative tool, the first and second investigative tools being useful in conducting fraud ring investigations;
communicating the first and second hyperlinks to the computing device, the first and second hyperlinks being displayable on the computing device;
receiving a selection of the first hyperlink or the second hyperlink;
in response to receiving the selection of the first hyperlink, launching a first investigative tool application; and
in response to receiving the selection of the second hyperlink, launching a second investigative tool application.

42. A computer program product for documenting fraud ring investigations in an enterprise environment, the computer program product comprising a non-transitory computer-readable medium having computer-readable program instructions stored therein, wherein said computer-readable program instructions comprise:
first instructions configured for generating a fillable form for electronically receiving data related to a fraud ring investigation;
second instructions configured for communicating the fillable form to a first fraud ring investigator, the fillable form being displayable on a computing device used by the first fraud ring investigator;
third instructions configured for electronically receiving a first set of data into the fillable form, the first set of data related to a first fraud ring investigation being conducted by the first fraud ring investigator; and
fourth instructions configured for electronically storing the first set of data related to the first fraud investigation in a memory.

43. The computer program product of claim 42, wherein said computer-readable program instructions further comprise:
fourth instructions configured for receiving one or more documents related to the first fraud ring investigation; and
fifth instructions configured for linking the one or more documents related to the first fraud investigation to the first set of data.
